(19) United States
(12) Patent Application Publication
(10) Pub. No.: US 2026/0284753 A1
(43) Pub. Date: Sep. 24, 2026

(54) CHUCK ARRANGEMENT COMPRISING A TURNABLE T-SLOT NUT PROVIDED WITH THREADED HOLES AND A METHOD FOR OPERATING THE SAME

(71) Applicant: M.P.C.-System AB, STOCKHOLM (SE)

(72) Inventor: Joel JÖNSSON, STOCKHOLM (SE)

(21) Appl. No.: 19/549,043

(22) Filed: Feb. 25, 2026

Related U.S. Application Data
(63) Continuation of application No. PCT/SE2024/050729, filed on Aug. 15, 2024.

(30) Foreign Application Priority Data
Aug. 29, 2023 (SE) 2351006-8

(51) Int. Cl. B23B 31/16

(52) U.S. Cl. CPC B23B 31/16279; B23B 31/16283; B23B 2270/16

(57) ABSTRACT

Chuck arrangement (100) having at least two chuck jaws (130) for clamping a workpiece (W), comprising radial tracks (120) for t-slot nuts (150) arranged to fasten a first chuck jaw part (132) to the track (120).

In some embodiments, both ends (151, 153) of the t-slot nut (150) are arranged to be positioned at a defined radial distance (157) from the radial inner end (121) of the track (120), and internally threaded holes (155) of the t-slot nut (150) are asymmetrically distributed along a radial (R) length of the t-slot nut (150).

In some embodiments, the number of internally threaded holes (155) in the t-slot nut (150) is at least three.

The invention also relates to a kit of parts and to a method.

The present invention relates to a chuck arrangement, as well as to a method for operating such chuck arrangement.

Chucks are used in many applications, in particular for holding a rotating workpiece, such as in a lathe, a CNC machine or the like. In particular in CNC machines, it is of crucial importance that the chuck jaws of a chuck can be positioned and held in a predetermined position with high accuracy, in order to predictably clamp a workpiece in an intended position and with an intended pressure. In order to address this problem, solutions such as the one presented in PCT/SE2012/050839 have been presented, in which the chuck jaws are individually configurable to hold the workpiece in a particular predetermined way with high accuracy.

In particular, chucks are used for fastening workpieces of different types and qualities, such workpieces then being rotated for machining or other processing at different rotation speeds.

A typical type of chuck device comprises a number of chuck jaws, where each such chuck jaw is used to apply a respective predetermined radially inward or outward directed pressing force onto the workpiece, holding it in place for rotation. Typically, there are at least two, or more often at least three, such chuck jaws, manufactured from metal material.

Different workpieces can have different diameters and/or different shapes. Therefore, the chuck jaws are normally adjustable, such as by the chuck jaws being continuously radially movable as controlled by a screw-engagement tensioning mechanism; by the chuck jaw having several abutment surfaces at different radial positions; by a clamping chuck jaw part being turnable so as to expose different sides to the clamped workpiece surface; or by different chuck jaw parts being used for different types of workpieces.

It is generally desirable to achieve an even and centred clamping of the workpiece in order to avoid damage and vibrations when the workpiece is rotated.

It is often also desirable to be able to achieve a clamping having repeatable characteristics in terms of position and alignment of the chuck jaws in relation to different but similar or identical workpieces.

The present invention solves one or several of the above-described problems and offers a chuck arrangement and a method that can clamp a wide variety of different types of workpieces in a predictable, reliable and repeatable manner. In addition, the presently proposed construction is simple and achieves a cost-efficient, sturdy, user-friendly and safe usage.

Hence, the invention relates to a chuck arrangement associated with a radial direction, an axial direction and an angular direction, the chuck arrangement being arranged to rotate in the angular direction about a central axial axis.

The chuck arrangement comprises at least two chuck jaws, each arranged to, in an assembled state of said chuck arrangement, be radially displaceable into a respective clamping position to apply a radial clamping force to a workpiece being held by the chuck arrangement.

The chuck arrangement further comprises radial tracks, each arranged to receive and accommodate a respective one of the chuck jaws so that the chuck jaw can be radially adjustable, each track having a radial inner end.

Each chuck jaw comprises a respective t-slot nut and a first chuck jaw part.

The t-slot nut has a first radial end and a second radial end, the t-slot nut further being arranged to move along the radial track and to radially fix the first chuck jaw part in relation to the track, the t-slot nut comprising internally threaded holes.

The first chuck jaw part comprises at least one through hole.

The first chuck jaw part is arranged to be fixed to the track by inserting at least one fixing screw through the through hole, into one of said internally threaded holes and threadedly engage with the internally threaded hole in question, thereby pulling together the first chuck jaw part and the t-slot nut.

Both the first radial end of the t-slot nut and, after turning the t-slot nut 180°, the second radial end of the t-slot nut is arranged to be positioned at a defined radial distance from the radial inner end of the track.

The internally threaded holes are distributed along a radial length of the t-slot nut so that a collection of radial distances associated with at least two of the internally threaded holes is distributed in the sense that no two such radial distances are the same, the collection of radial distances comprising a respective radial distance from the radial inner end of the track to a respective central axis of each of the internally threaded holes in question for both when the first radial end and second radial end is positioned at said defined distance from the radial inner end of the track.

In some embodiments, respective abutment surfaces of the first radial end and the second radial end share a common shape.

In some embodiments, no two radial distances in the collection of radial distances are less than 2 mm apart.

In some embodiments, the radial distances in the collection of radial distances are equidistantly arranged.

In some embodiments, the chuck arrangement comprises a set of gripping teeth associated with the track.

The first chuck jaw part can comprise a corresponding set of gripping teeth, allowing the first chuck jaw part to be positioned in any one of a discrete set of radial positions by said gripping teeth engaging to define such a radial position.

A radial distance between at least one pair, or several pairs, or each pair, of adjacent radial distances in the collection of radial distances can be equal to the radial distance between a predetermined number of said gripping teeth.

In some embodiments, a distance between at least one pair, or several pairs, or each pair, of adjacent radial distances in the collection of radial distances is at least 2 mm, or at least 4 mm.

In some embodiments, a distance between at least one pair, or several pairs, or each pair, of adjacent radial distances in the collection of radial distances is at the most 20 mm, at the most 10 mm, or at the most 6 mm.

Moreover, the invention relates to a chuck arrangement wherein the number of internally threaded holes in the t-slot nut is at least three, so that the first chuck jaw part can be fastened to the t-slot nut in at least two radially different positions using at least two through holes in the first chuck jaw part for each such radial fastening position.

In some embodiments, the number of through holes in the first chuck jaw part is smaller than the number of internally threaded holes in the t-slot nut.

In some embodiments, the t-slot nut comprises at least four or at least five internally threaded holes.

In some embodiments, at least one, at least two, or all, of the internally threaded holes are blind holes.

In some embodiments, at least two of said internally threaded holes partly overlap in the radial di-rection.

In some embodiments, the first chuck jaw part comprises at least two through holes.

In some embodiments, one of the two through holes is centrally located in relation to the first chuck jaw part whereas the other is peripherally located in relation to the first chuck jaw part.

In some embodiments, the first chuck jaw part is a backing chuck jaw part.

In some embodiments, the chuck jaw further comprises a clamping chuck jaw part.

In some embodiments, a fixing screw running through the centrally located through hole of the first chuck jaw part is arranged to also run through a corresponding through hole through the clamping chuck jaw part so as to fasten the clamping chuck jaw part to the backing chuck jaw part.

In some embodiments, the clamping chuck jaw part is arranged to pivot about an axial pivot axis defined by said fixing screw running through said centrally located through hole.

In some embodiments, the chuck jaw further comprises a clamping chuck jaw part.

In some embodiments, the clamping chuck jaw part is pivotable about an axial pivot axis and the clamping chuck jaw part comprises several gripping surfaces, arranged at different radial distances from, and at different angular locations in relation to, the pivot axis.

In some embodiments, the clamping chuck jaw part comprises several gripping surfaces, arranged at different radial distances from the pivot axis and at different axial locations.

In some embodiments, a spring-loaded stop screw, arranged to be accommodated into and run through a corresponding inner-threaded axial through hole in the t-slot nut and then to be pressed, due to said spring-loading, against an axial abutment surface of the track so as to create a friction force that must be overcome to radially move the t-slot nut in the track.

In some embodiments, the spring-loaded stop screw, when pressed against the axial abutment sur-face, does not axially protrude outside of the t-slot nut at an axially facing side of the t-slot nut being opposite to an axially facing side of the t-slot nut facing the axial abutment surface of the track.

The invention further relates to a method for operating a chuck arrangement of said type, the method comprising the steps
inserting the t-slot nut into the track with the first radial end radially inwards;
fastening the first chuck jaw part to the track by inserting and tightening a first fixing screw through a first through hole of the first chuck jaw part and a first internally threaded hole of the t-slot nut;
operating the chuck arrangement to clamp a workpiece;
releasing the first chuck jaw part from the track by undoing the first fixing screw;
at least one of
firstly, inserting the t-slot nut into the track with the second radial end radially inwards and fastening the first chuck jaw part to the track by inserting and tightening the first fixing screw, or a second fixing screw, through the first or a second through hole of the first chuck jaw part and the first or a second internally threaded hole of the t-slot nut; and
secondly, fastening the first chuck jaw part to the track by inserting and tightening the first fixing screw, or a second fixing screw, through the first through hole of the first chuck jaw part and a second internally threaded hole of the t-slot nut, the second internally threaded hole of the t-slot nut being different from the first internally threaded hole of the t-slot nu; and
operating the chuck arrangement to clamp a workpiece.

In some embodiments, in said inserting, the t-slot nut is inserted to a defined radial distance from the radial inner end of the track.

In some embodiments, the defined radial distance is achieved by at least one of
firstly, fully inserting the t-slot nut into the track so that its first radial end abuts directly with the radial inner end of the track;
secondly, inserting the t-slot nut into the track and using a distance-defining tool to adjust the radial position of at least three t-slot nuts in relation to each other, the at least three t-slot nuts being radially movable in a respective track; and
thirdly, fine-adjusting a radial location of the t-slot nut by temporarily fastening the first chuck jaw part to the t-slot nut and radially moving the first chuck jaw part so that aligned engagement is achieved between cooperating gripping teeth arranged on the track and on the first chuck jaw part at a nearest possible radial location of the t-slot nut for such engagement to be possible.

In some embodiments, the method further comprises the steps
releasing the first chuck jaw part from the track;
turning the first chuck jaw part 180° about an axial axis; and
fastening the first chuck jaw part to the track, using a fixing screw running through a through hole of the first chuck jaw part and an internally threaded hole of the t-slot nut, in the new orientation of the first chuck jaw part resulting from said turning.

In some embodiments, the method further comprising the steps
fastening a clamping chuck jaw part to the first chuck jaw part, the first chuck jaw part then being a backing chuck jaw part of the chuck jaw; and
clamping the workpiece by bringing a first gripping surface of the clamping chuck jaw part into contact with the workpiece;
releasing the workpiece; and
clamping the workpiece by bringing a second gripping surface of the clamping chuck jaw into contact with the workpiece,
where the second gripping surface is either exposed to the workpiece by pivoting the clamping chuck jaw about an axial pivot axis or by translating the workpiece in the axial direction.

In some embodiments, the method further comprising the steps
inserting the t-slot nut into the track;
screwing a spring-loaded stop screw of the chuck arrangement into an internally threaded axial through hole of the t-slot nut and into pressing engagement with an axial abutment surface of the track so as to create a friction force that must be overcome to radially move the t-slot nut in the track, the friction being due to said spring-loading;
bringing the first chuck jaw part into loose engagement with the t-slot nut using a fixing screw running through a through hole of the first chuck jaw part and into an internally threaded hole of the t-slot nut;
fine-adjusting, against said friction force, the t-slot nut radially until aligned engagement is achieved between cooperating gripping teeth arranged on the first chuck jaw part and on the track;
removing the first chuck jaw part from the t-slot nut;
fully fastening the stop screw by screwing it further into pressing engagement with the axial abutment surface of the track; and
fastening the first chuck jaw part to the track using a fixing screw running through a through hole of the first chuck jaw part and into an internal-ly threaded hole of the t-slot nut.

In some embodiments, the fine-adjusting of the t-slot nut is 1 mm or less radially.

The invention also relates to a kit of parts, comprising
a chuck arrangement of said type, the chuck arrangement comprising at least three chuck jaws; and
a distance-defining tool, comprising three parallel guide pins arranged in a triangle, a plane of the triangle being perpendicular to a general longitudinal direction of the guide pins, each guide pin being arranged to radially align with a corresponding internally threaded hole in a respective one of three different t-slot nuts when each of said three different t-slot nuts are inserted into the corresponding track and radially positioned at a defined radial distance from the radial inner end of the track in question.

The invention furthermore relates to a method for operating such a kit of parts, the method comprising the steps
inserting each of three t-slot nuts of the chuck arrangement of the kit of parts into a respective track;
adjusting the radial positions of said three t-slot nuts in concert by inserting a respective one of said three guide pins into a respective internally threaded hole of each t-slot nut; and
fastening each of the three t-slot nuts to the respective track.

In the following, the invention will be described in detail, with reference to exemplifying embodiments of the invention and to the enclosed drawings, wherein:

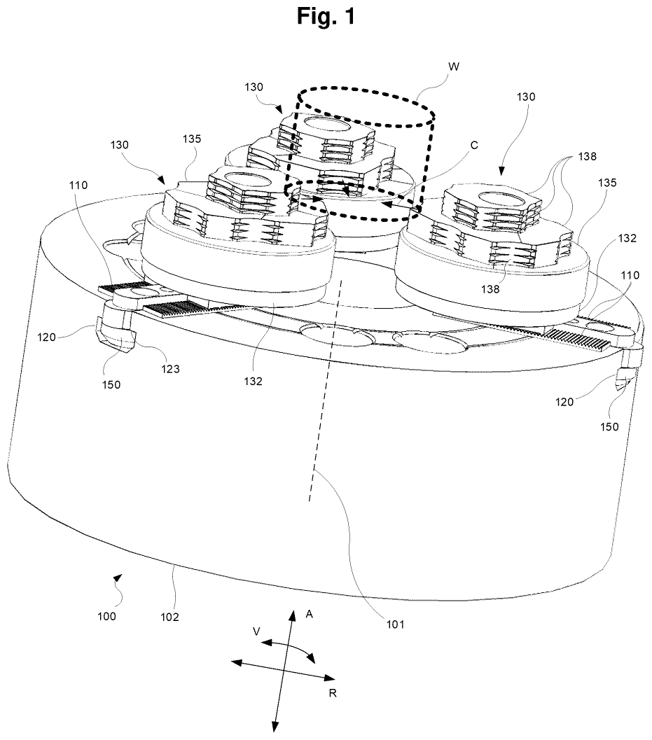

FIG. 1 is a perspective view of a first-embodiment chuck arrangement, having three chuck jaws, FIG. 1 also showing a workpiece;

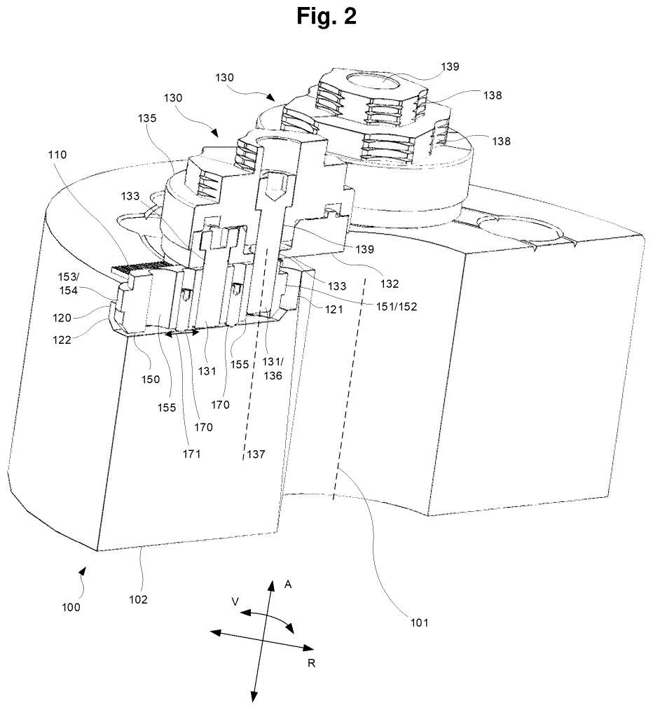

FIG. 2 is a perspective section view of the first-embodiment chuck arrangement, with a first-embodiment chuck jaw in a first radial position;

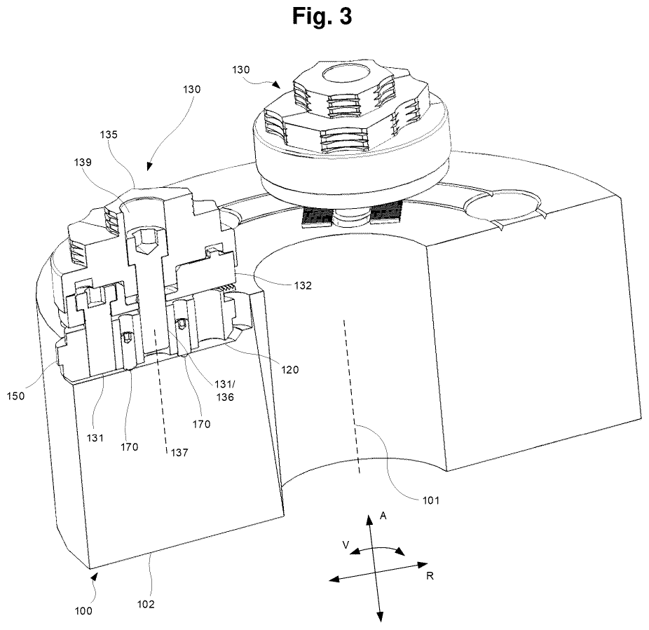

FIG. 3 is a perspective section view of the first-embodiment chuck arrangement, with the first-embodiment chuck jaw in a second radial position;

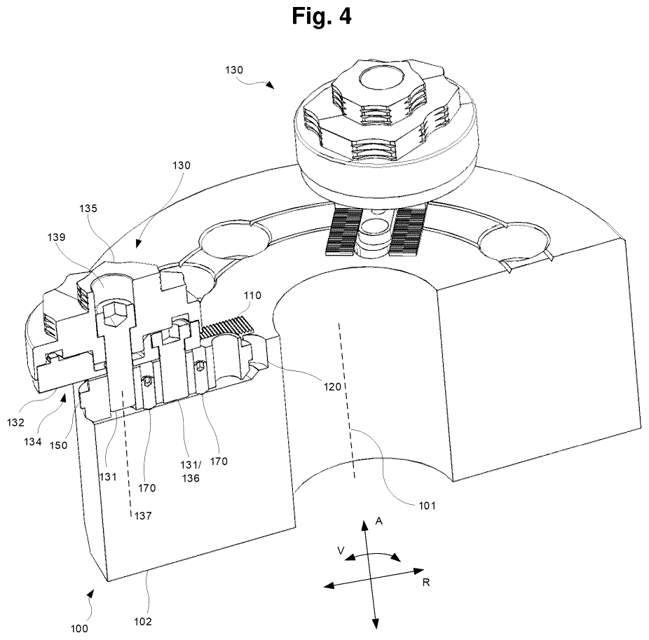

FIG. 4 is a perspective section view of the first-embodiment chuck arrangement, with the first-embodiment chuck jaw in a third radial position;

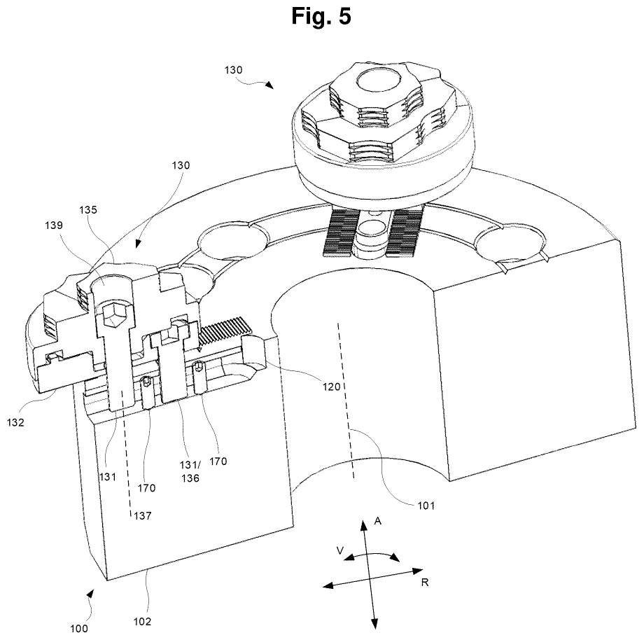

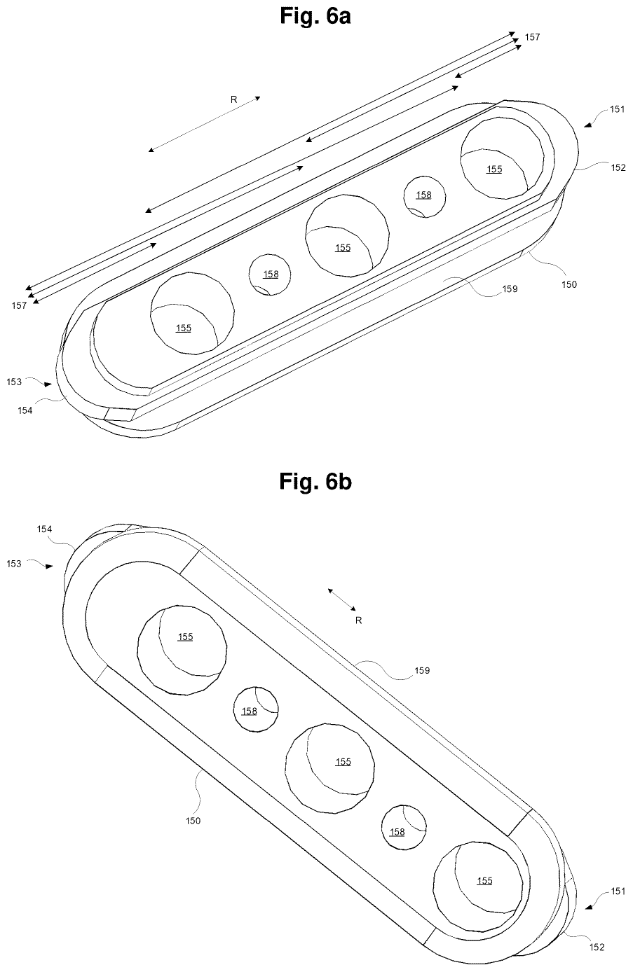

FIG. 5 corresponds to FIG. 4, but with a first-embodiment t-slot nut removed;

FIGS. 6a and 6b show respective perspective views of the first-embodiment t-slot nut;

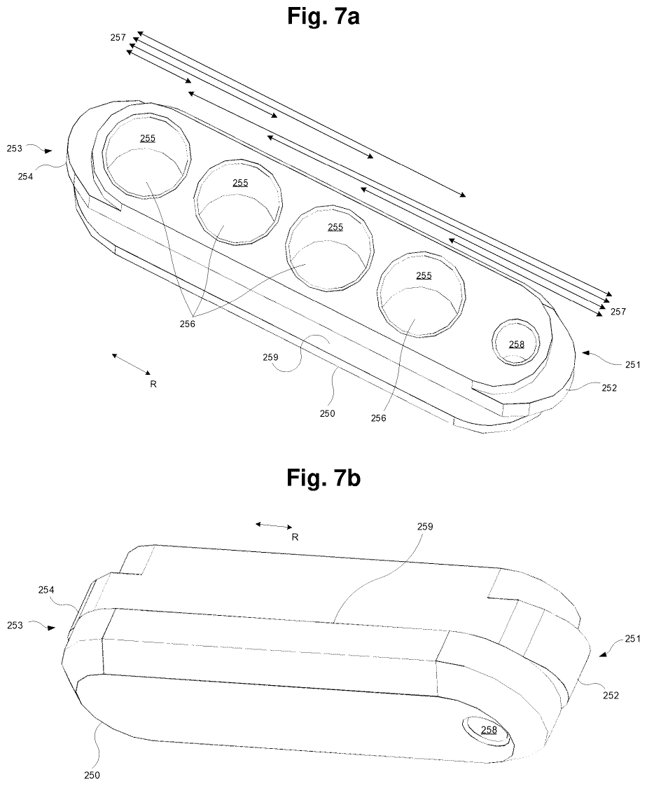

FIGS. 7a and 7b show respective perspective views of a second-embodiment t-slot nut;

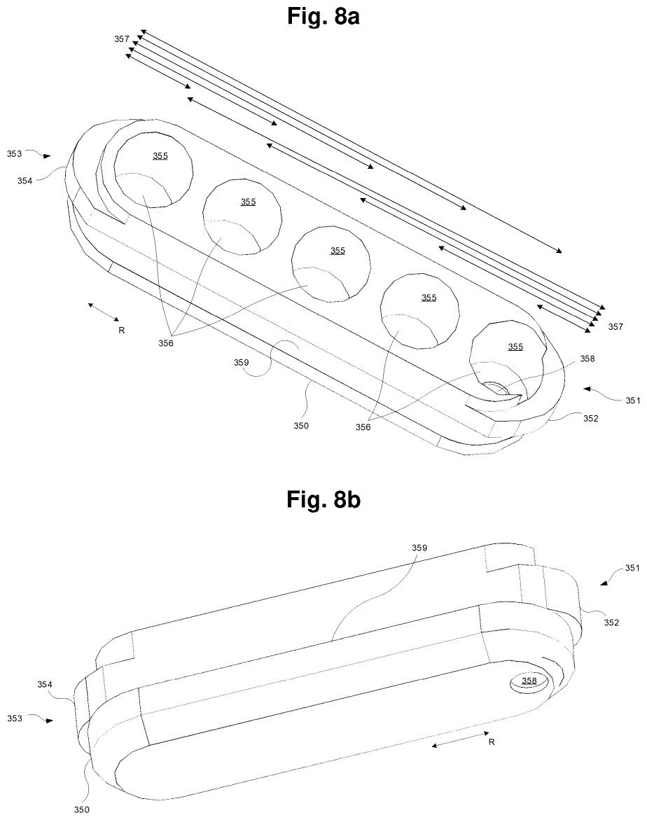

FIGS. 8a and 8b show respective perspective views of a third-embodiment t-slot nut;

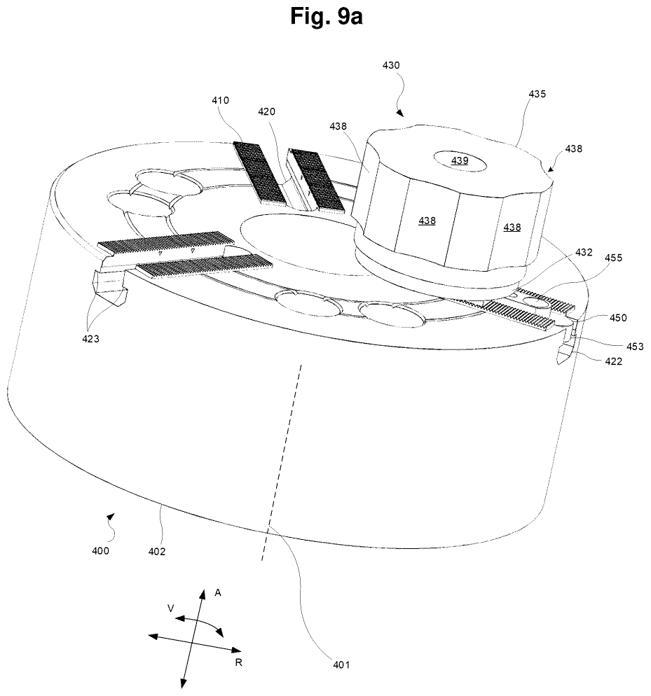

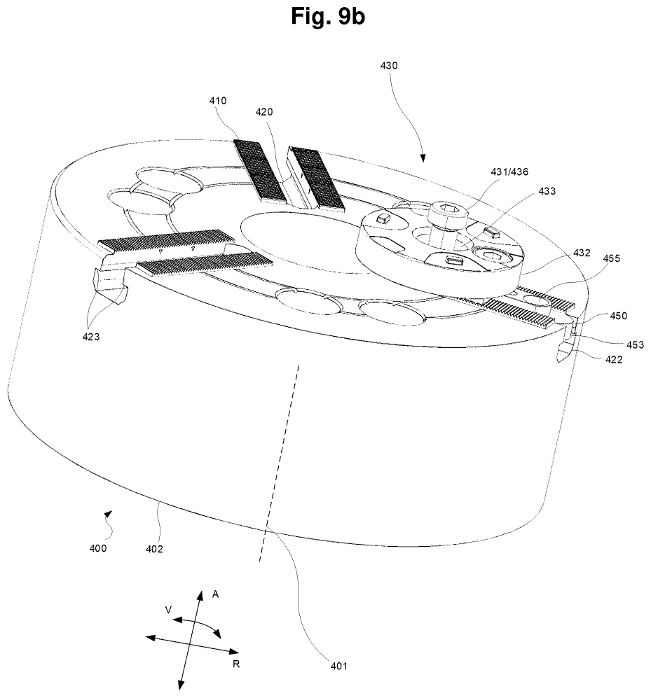

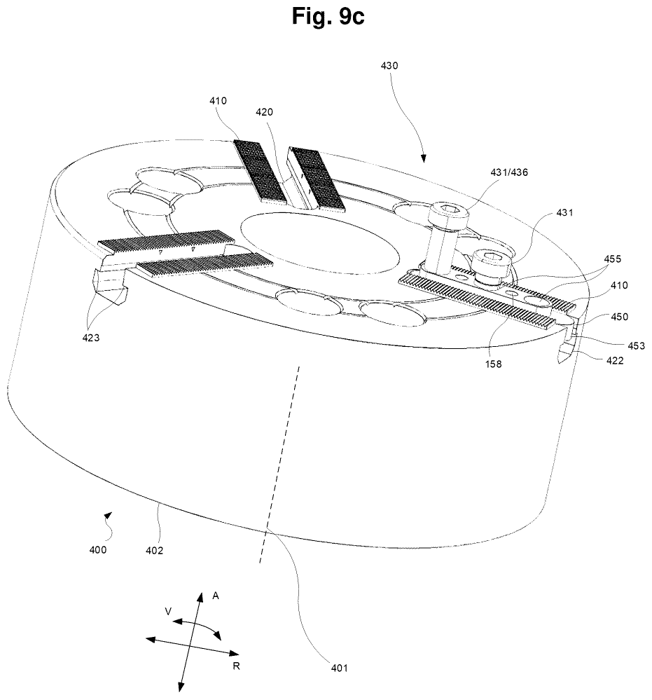

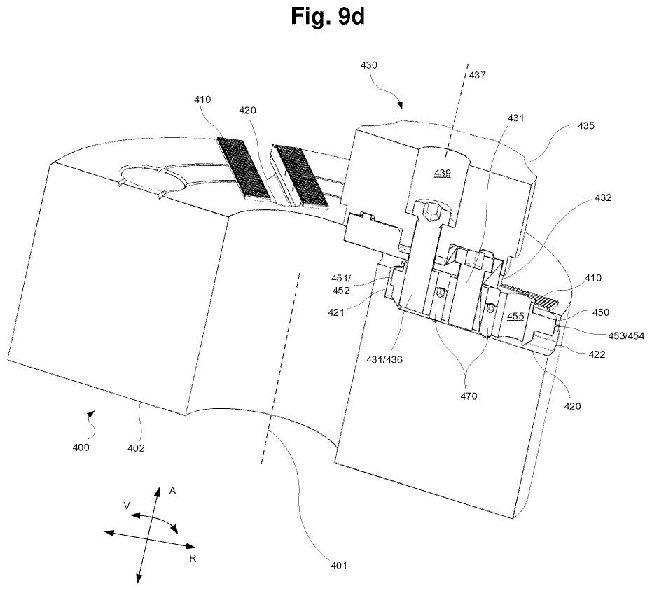

FIG. 9a is a perspective view of a fourth-embodiment chuck arrangement, showing only one (out of three) fourth-embodiment chuck jaw for reasons of simplicity;

FIG. 9b corresponds to FIG. 9a, but with a fourth-embodiment clamping chuck jaw part removed;

FIG. 9c corresponds to FIG. 9b, but further with a fourth-embodiment backing chuck jaw part removed;

FIG. 9d corresponds to FIG. 9a, but showing a perspective section view, the fourth-embodiment chuck jaw being in a first radial position, a fourth-embodiment t-slot nut being in a first orientation and the fourth-embodiment backing chuck jaw part being in a first orientation;

FIG. 9e is a perspective view of the fourth-embodiment chuck jaw from below;

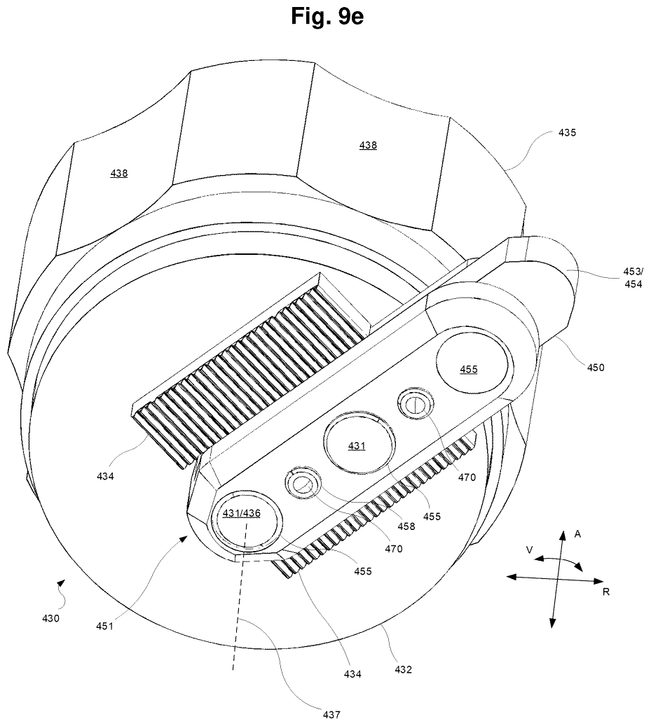

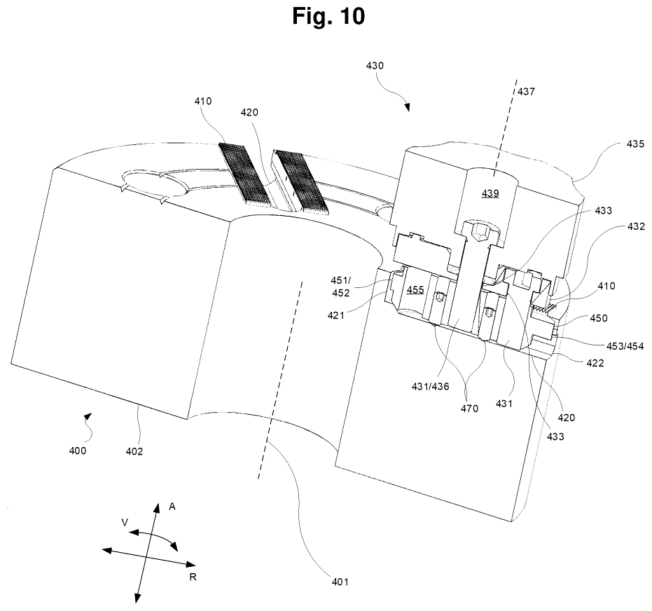

FIG. 10 corresponds to FIG. 9d, but shows the fourth-embodiment chuck jaw in a second position, the fourth-embodiment t-slot nut being in the first orientation and the fourth-embodiment backing chuck jaw part being in the first orientation;

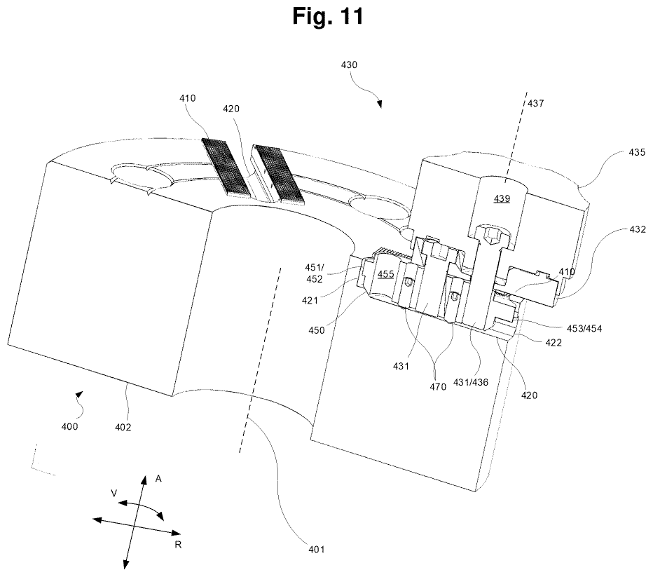

FIG. 11 corresponds to FIG. 9d, but shows the fourth-embodiment chuck jaw in a third position, the fourth-embodiment t-slot nut being in the first orientation and the fourth-embodiment backing chuck jaw part being in a second orientation;

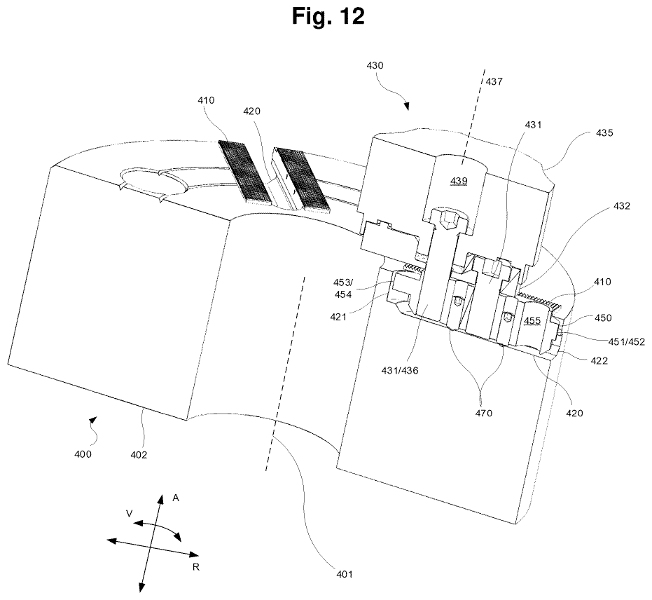

FIG. 12 corresponds to FIG. 9d, but shows the fourth-embodiment chuck jaw in a fourth position, the fourth-embodiment t-slot nut being in a second orientation and the fourth-embodiment backing chuck jaw part being in the first orientation;

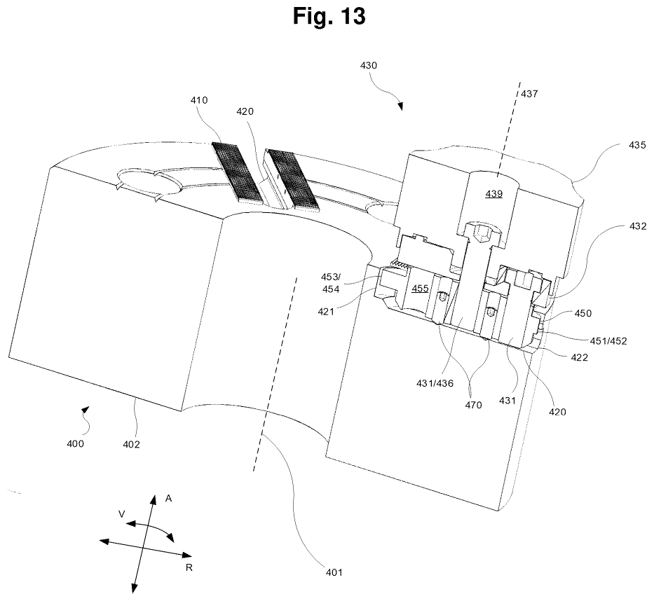

FIG. 13 corresponds to FIG. 9d, but shows the fourth-embodiment chuck jaw in a fourth position, the fourth-embodiment t-slot nut being in the second orientation and the fourth-embodiment backing chuck jaw part being in the first orientation;

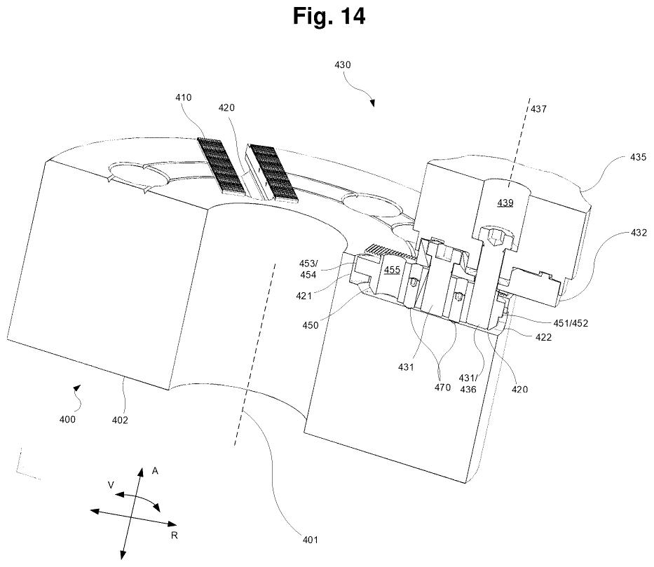

FIG. 14 corresponds to FIG. 9d, but shows the fourth-embodiment chuck jaw in a sixth position, the fourth-embodiment t-slot nut being in the second orientation and the fourth-embodiment backing chuck jaw part being in the second orientation;

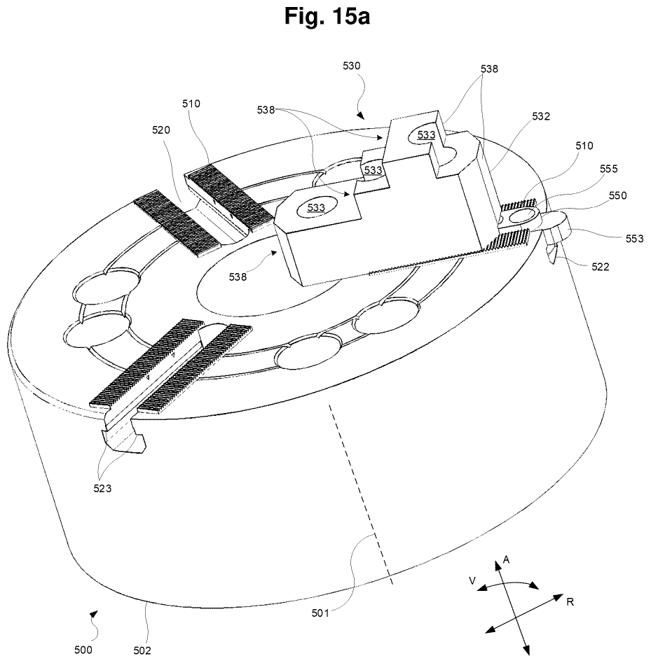

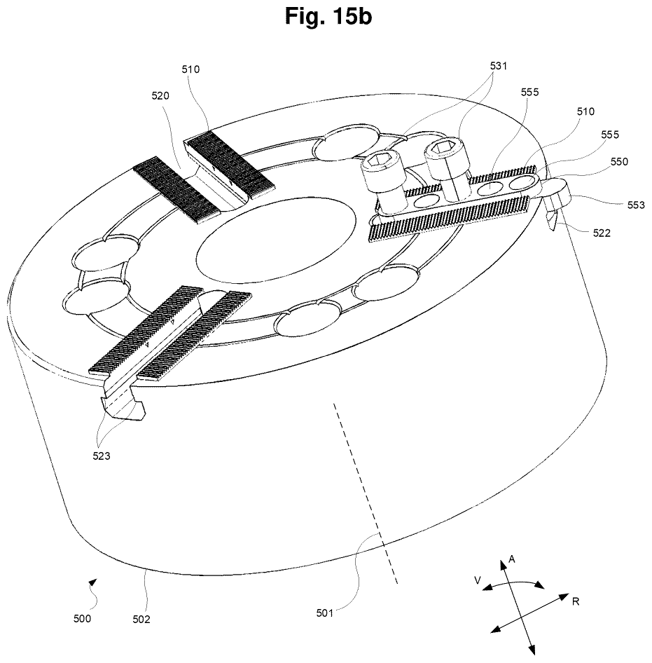

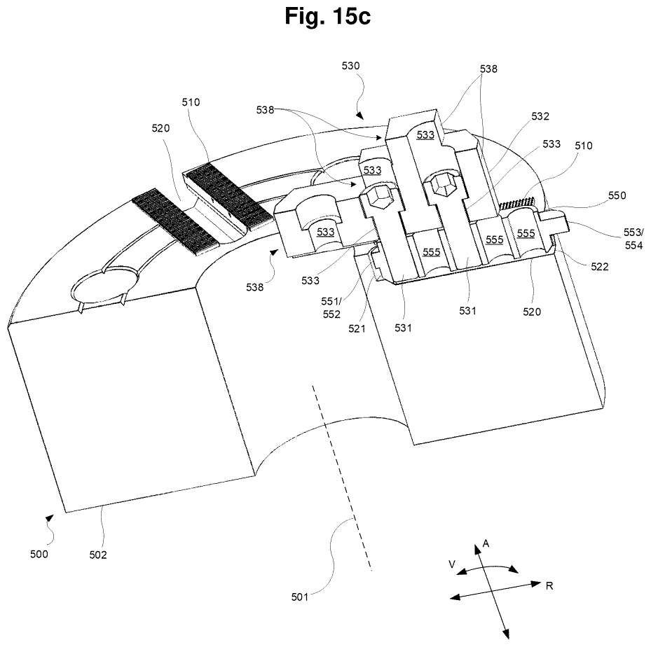

FIG. 15a is a perspective view of a fifth-embodiment chuck arrangement, showing only one (out of three) fifth-embodiment chuck jaw for reasons of simplicity;

FIG. 15b corresponds to FIG. 15a, but with a fifth-embodiment clamping chuck jaw part removed;

FIG. 15c corresponds to FIG. 15a, but showing a perspective section view, the fifth-embodiment chuck jaw being in a first radial position, a fifth-embodiment t-slot nut being in a first orientation and the fifth-embodiment clamping chuck jaw being in a first orientation;

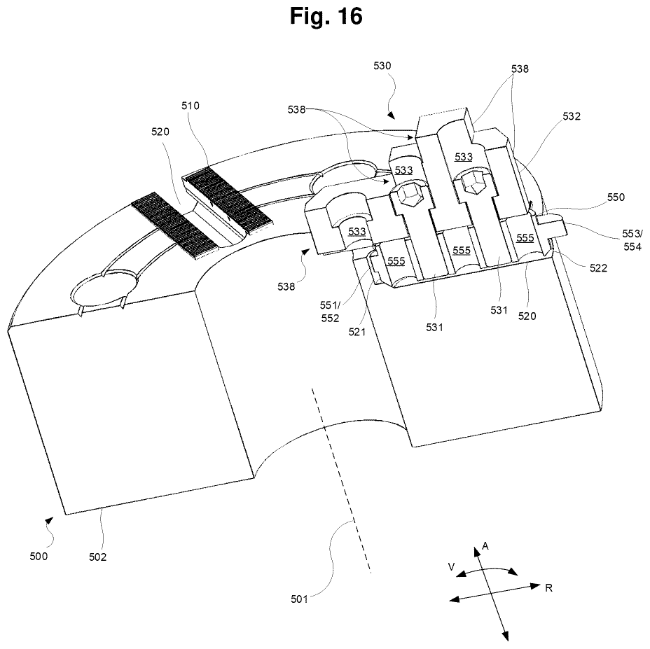

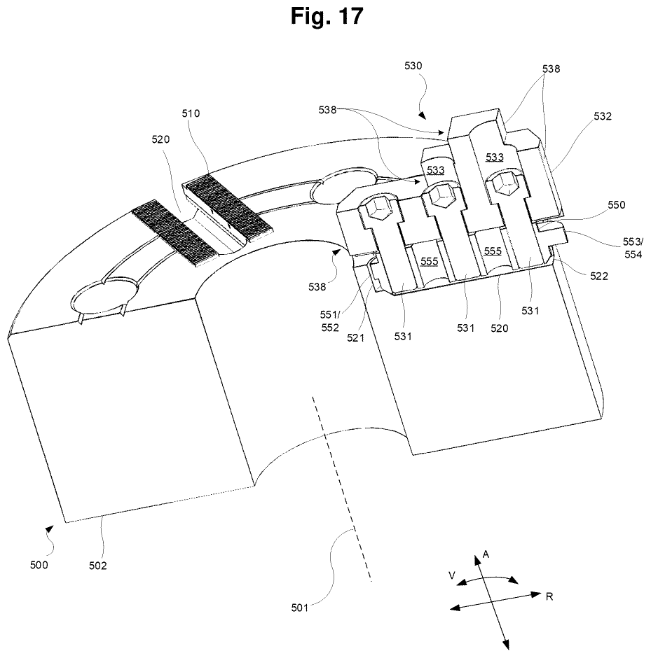

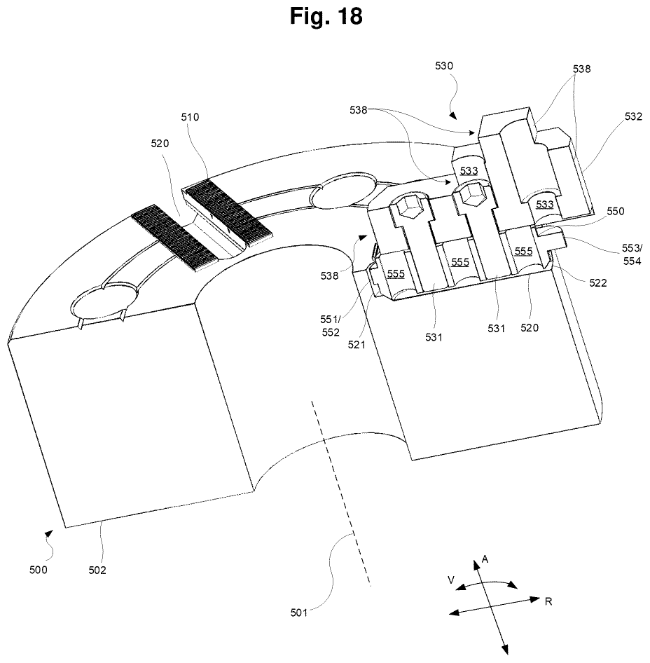

FIGS. 16-18 each corresponds to FIG. 15c, but shows the fifth-embodiment chuck jaw in a second, third and fourth position, respectively, the fifth-embodiment t-slot nut being in the first orientation and the fifth-embodiment clamping chuck jaw being in the first orientation;

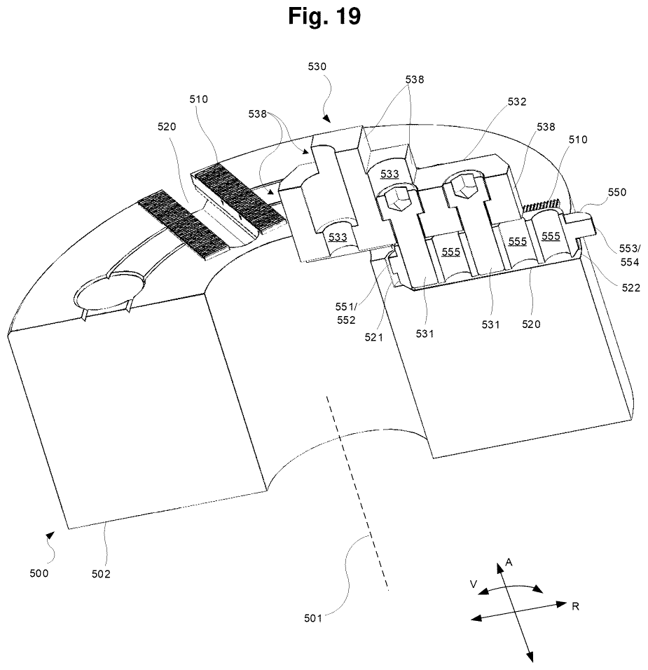

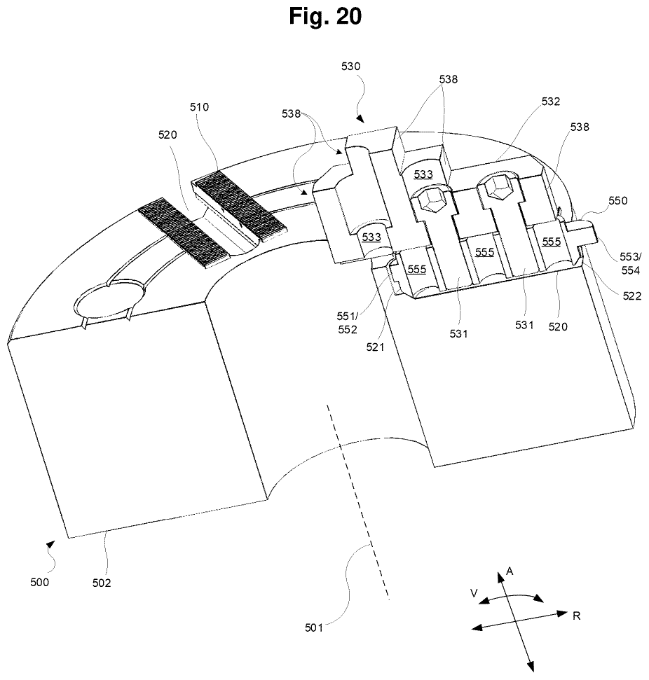

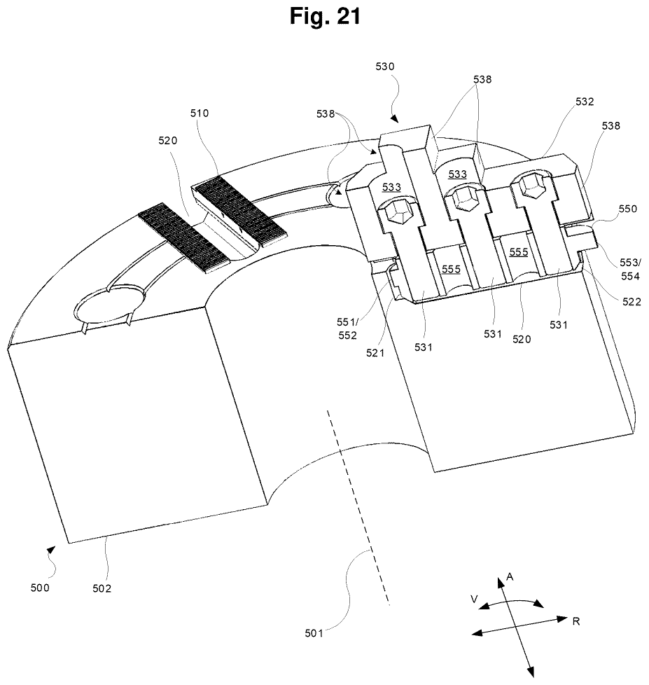

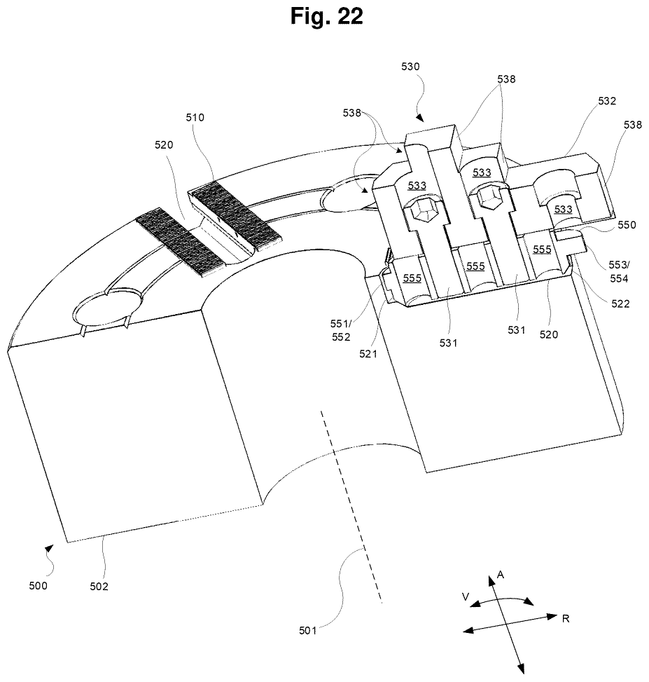

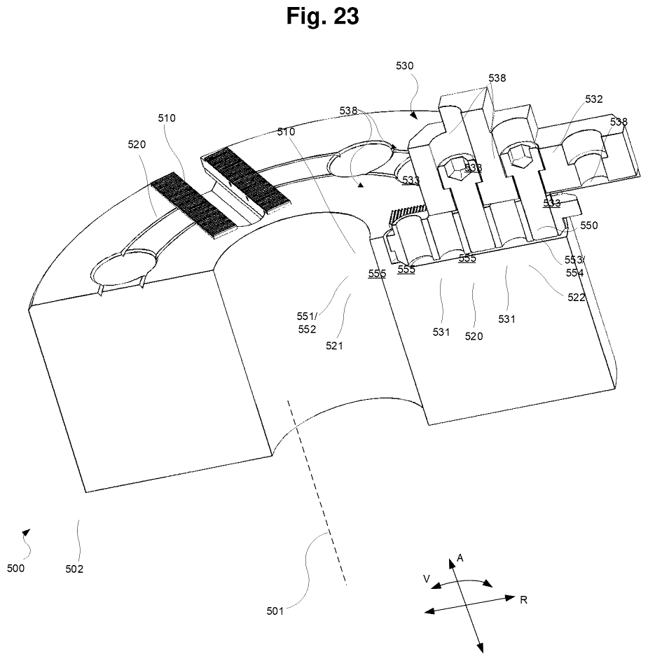

FIGS. 19-23 each corresponds to FIG. 15c, but shows the fifth-embodiment chuck jaw in a fifth, sixth, seventh, eighth and ninth position, respectively, the fifth-embodiment t-slot nut being in the first orientation and the fifth-embodiment clamping chuck jaw being in a second orientation;

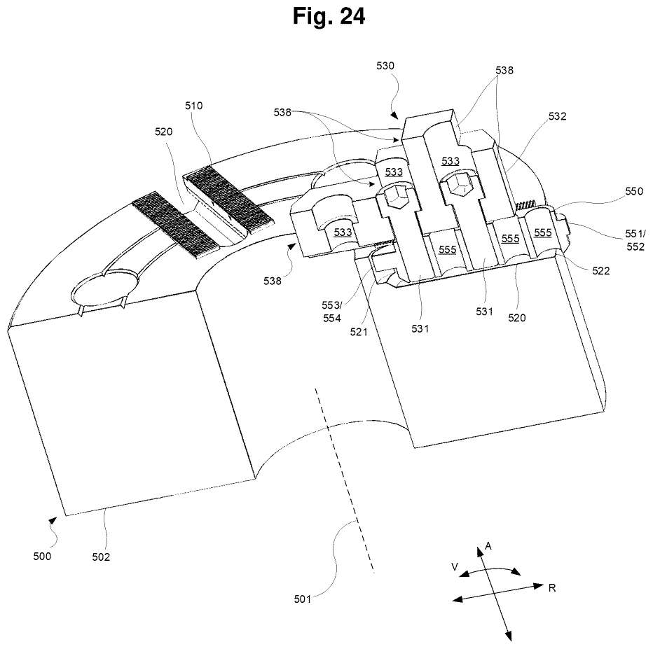

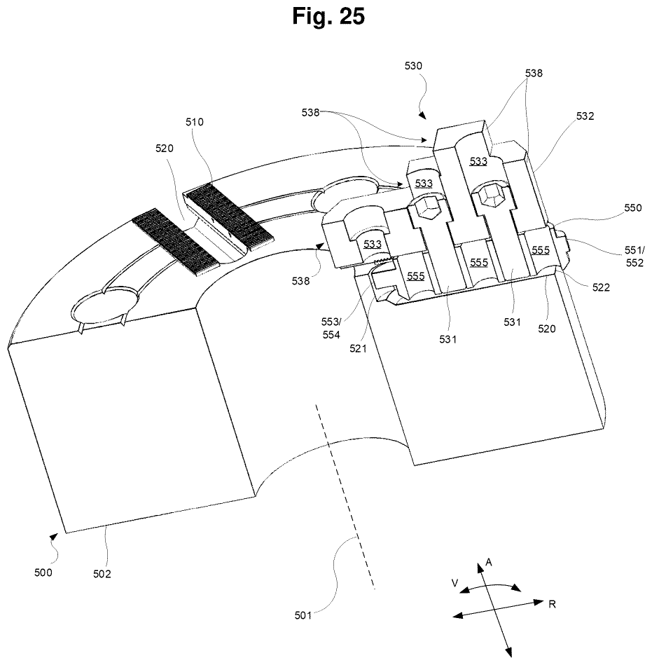

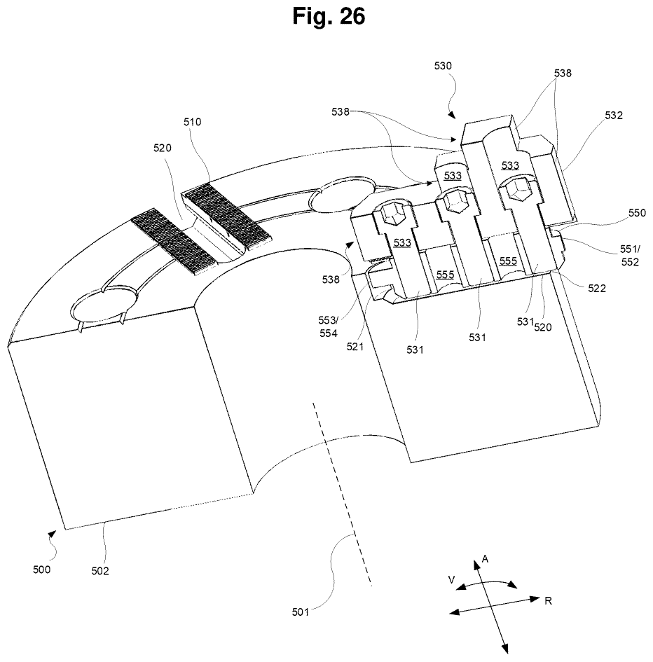

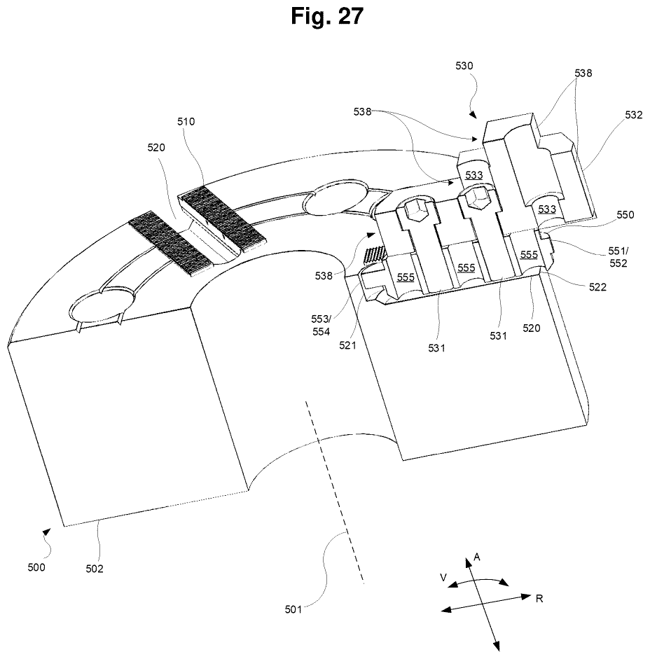

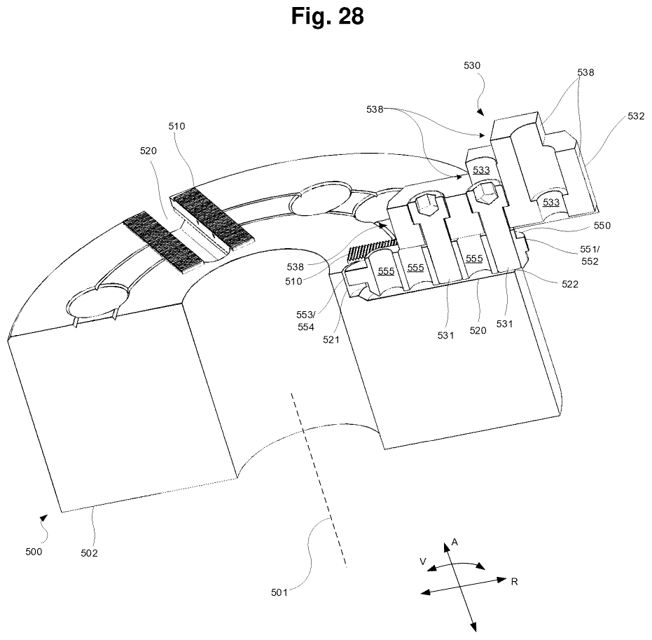

FIGS. 24-28 each corresponds to FIG. 15c, but shows the fifth-embodiment chuck jaw in a tenth, eleventh, twelfth, thirteenth and fourteenth position, respectively, the fifth-embodiment t-slot nut being in a second orientation and the fifth-embodiment clamping chuck jaw being in the first orientation;

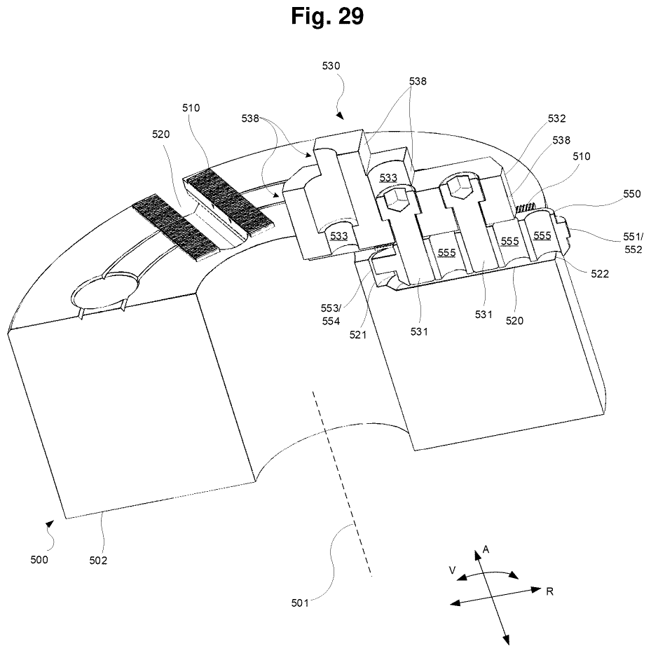

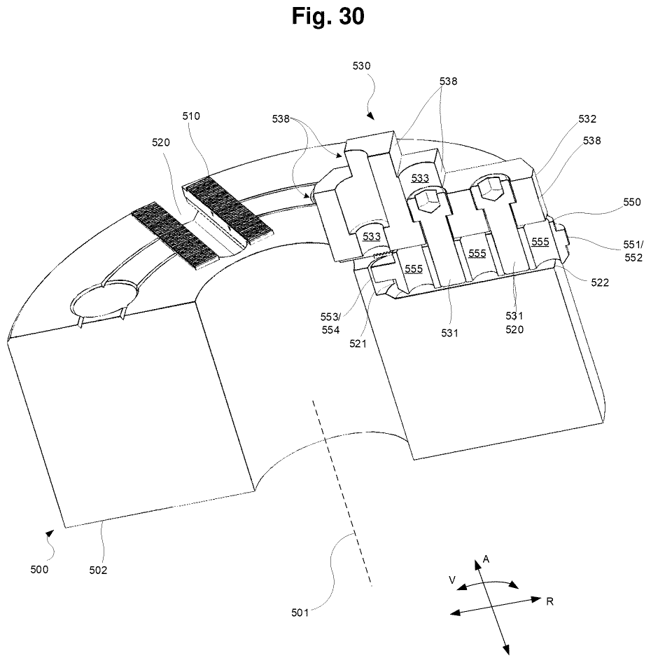

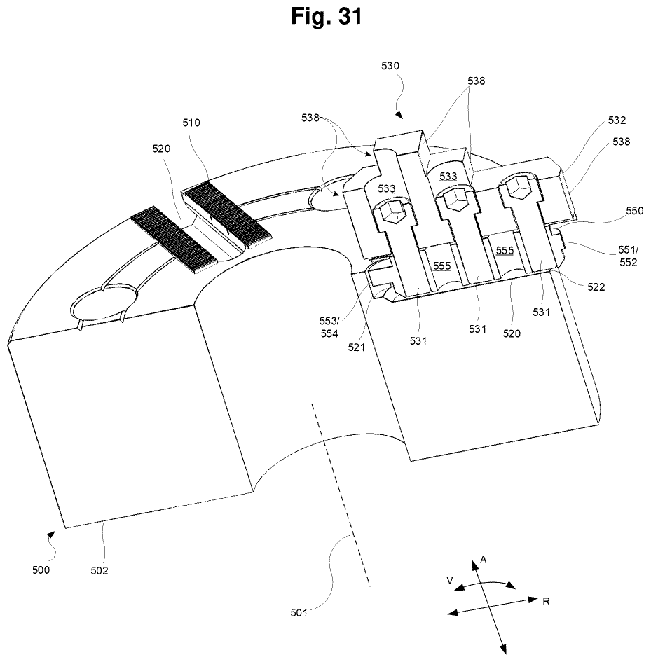

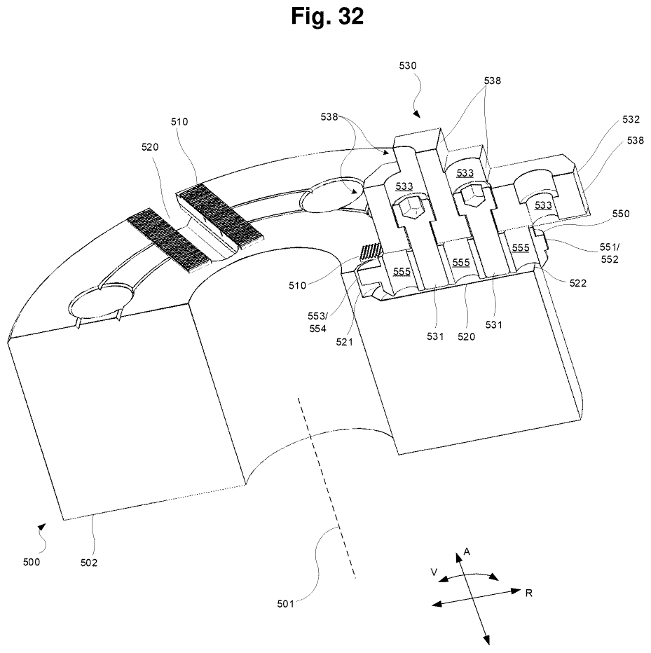

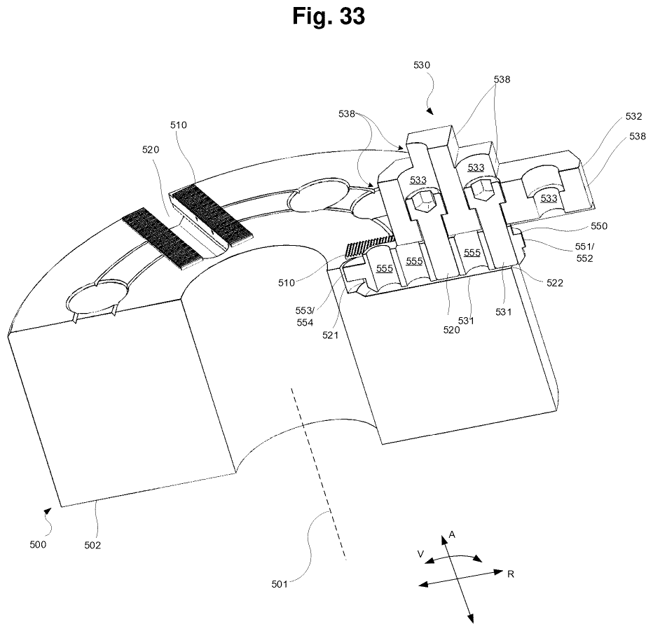

FIGS. 29-33 each corresponds to FIG. 15c, but shows the fifth-embodiment chuck jaw in a fifteenth, sixteenth, seventeenth, eighteenth and nineteenth position, respectively, the fifth-embodiment t-slot nut being in the second orientation and the fifth-embodiment clamping chuck jaw being in the second orientation;

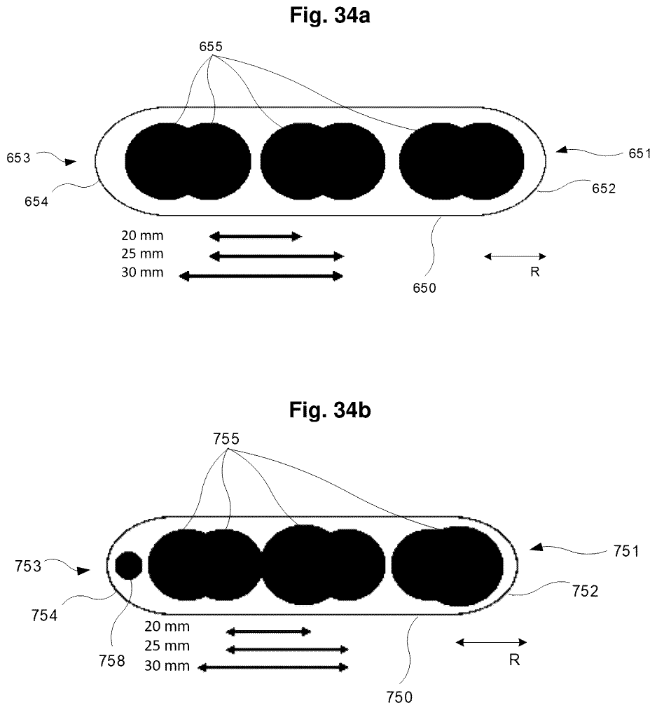

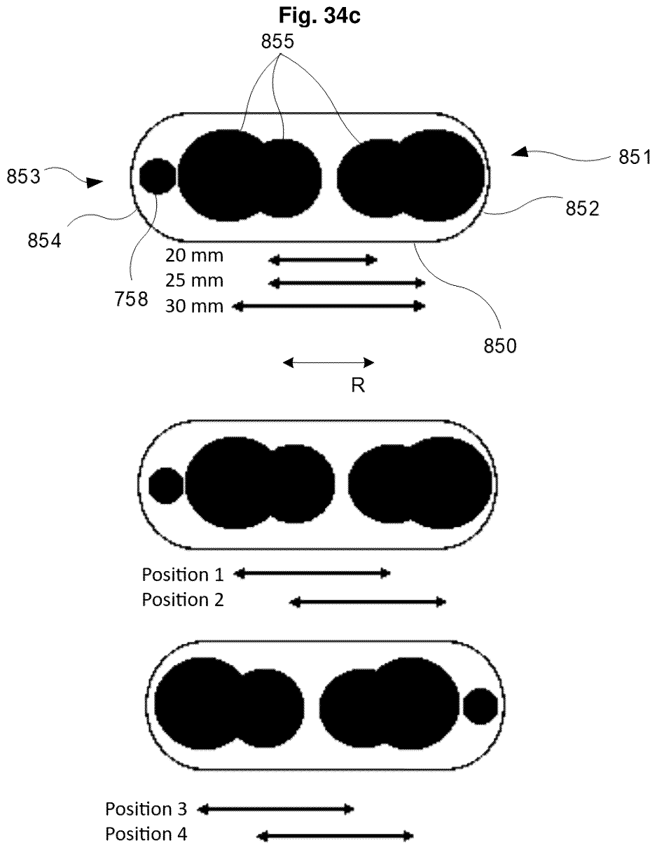

FIG. 34a is a simplified plan view of a sixth-embodiment t-slot nut;

FIG. 34b is a simplified plan view of a seventh-embodiment t-slot nut;

FIG. 34c is a simplified plan view of an eight-embodiment t-slot nut, also showing various fastening positions of an eighth-embodiment chuck jaw (not shown) with respect to the eighth-embodiment t-slot nut;

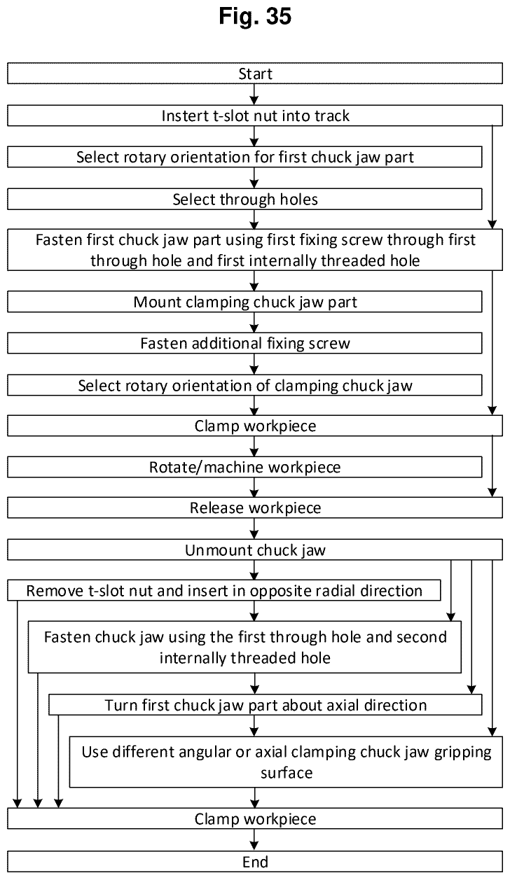

FIG. 35 is a flowchart illustrating a first method;

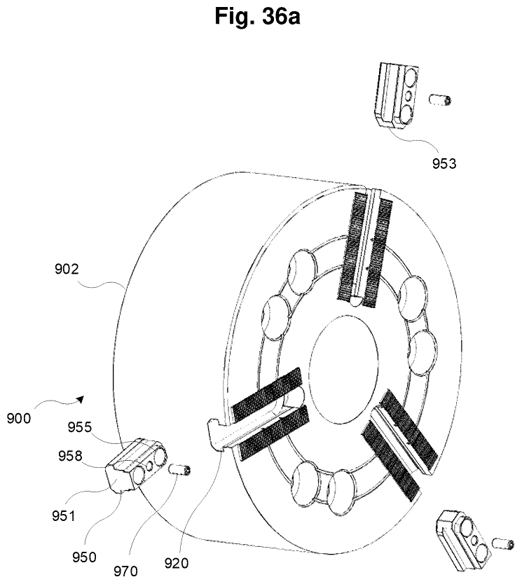

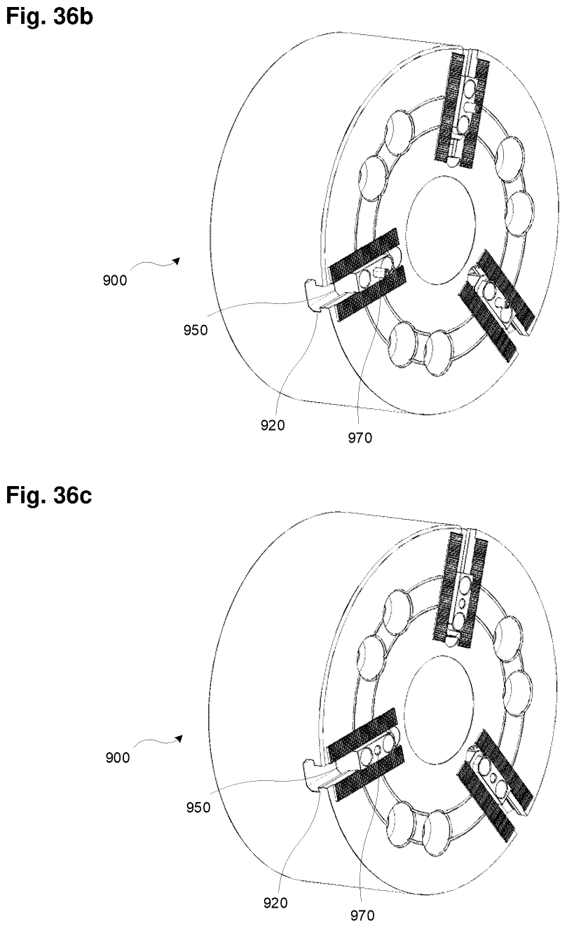

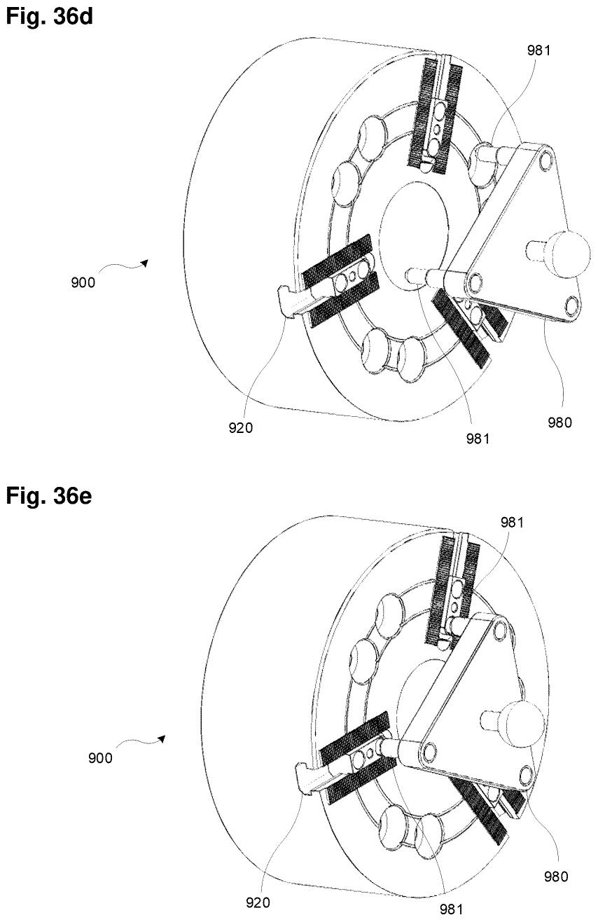

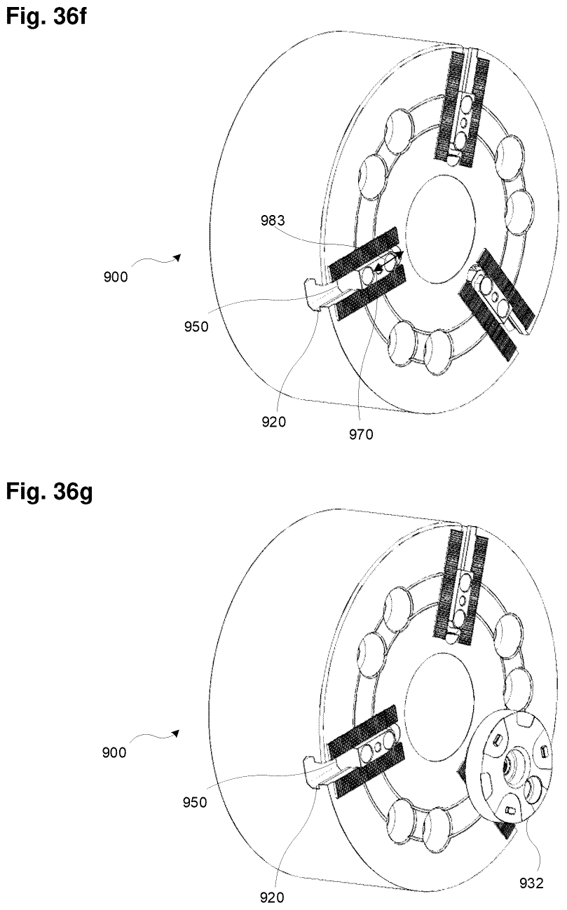

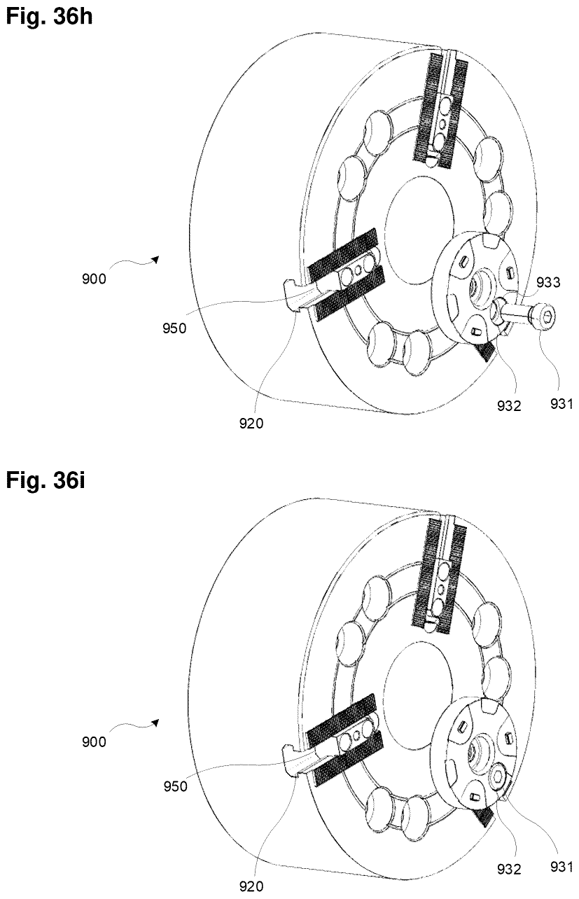

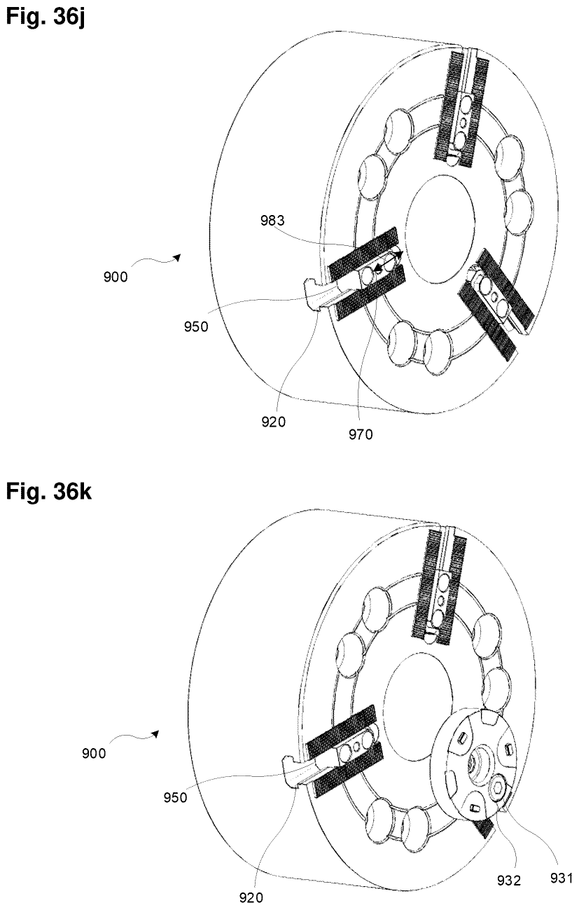

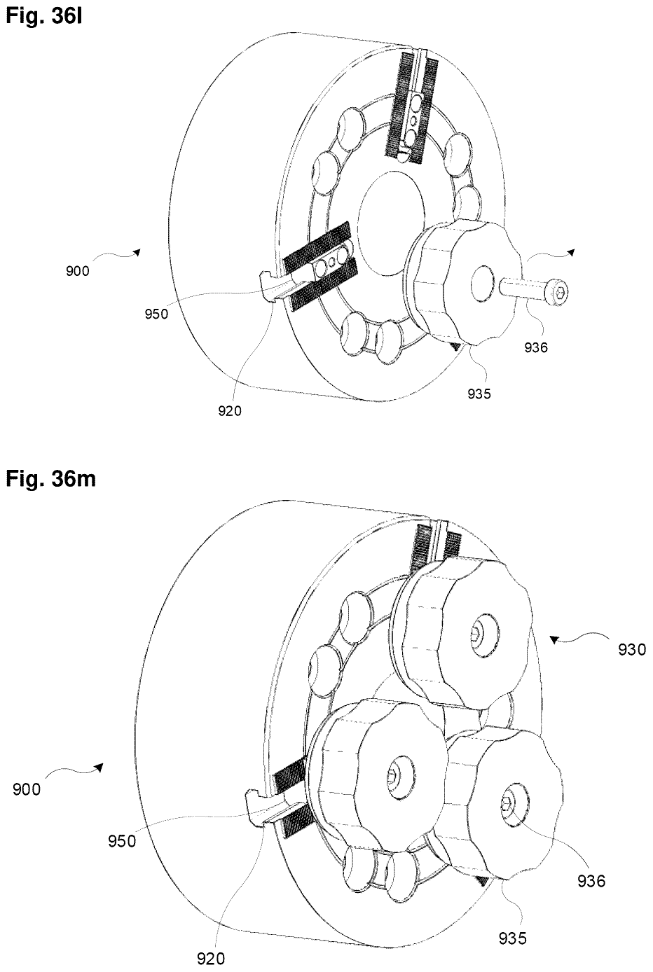

FIGS. 36a-36m illustrate a nineth-embodiment chuck arrangement in a series of progressive mounting steps;

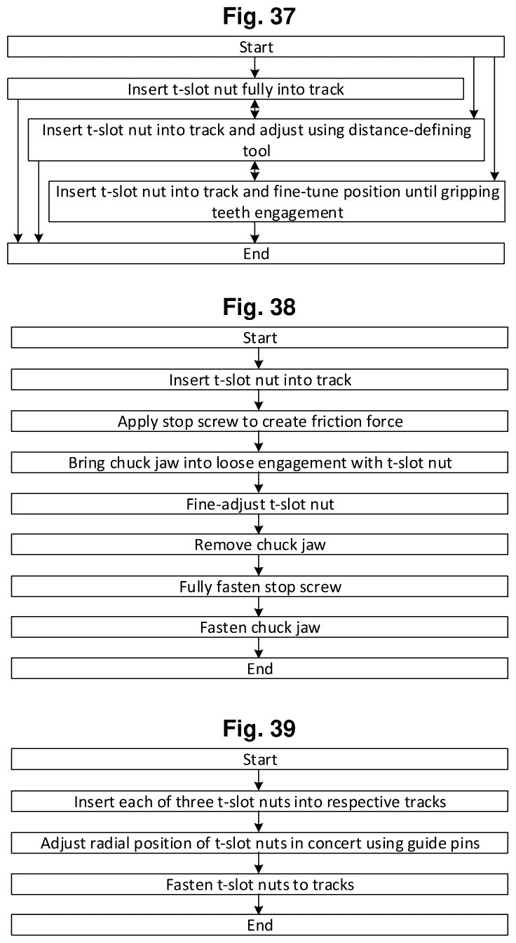

FIG. 37 is a flowchart illustrating a second method;

FIG. 38 is a flowchart illustrating a third method;

FIG. 39 is a flowchart illustrating a fourth method;

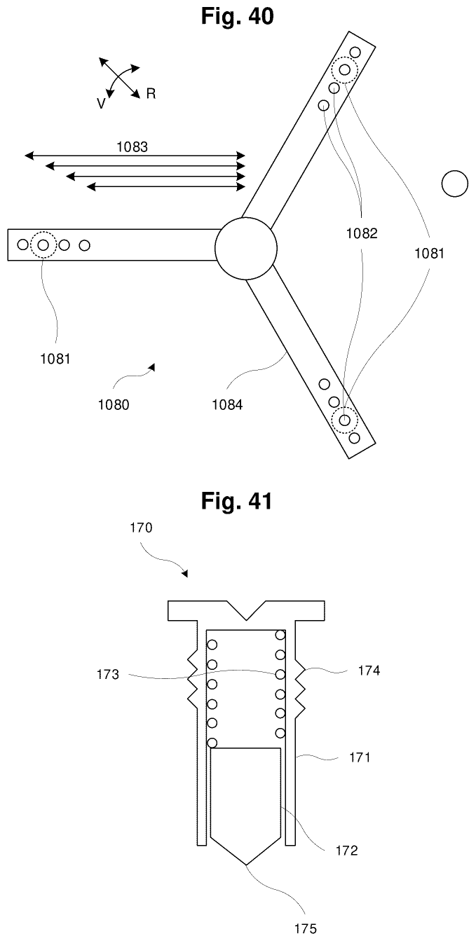

FIG. 40 is a simplified view of a distance-defining tool; and

FIG. 41 shows a stop spring.

All Figures share the same last two digits of the reference numerals for same or corresponding parts. In three-digit reference numerals, the first digit signifies a particular embodiment example. In four-digit reference numerals, the first two digits signify a particular embodiment example. In the following, as soon as one three-digit or four-digit reference numeral is referenced, either in direct connection to a particular described embodiment example or as a general reference, it is realized that the corresponding is equally applicable to same or corresponding parts in other embodiment examples described herein. Hence, for brevity the text may refer to only reference numeral “100” when discussing the “chuck arrangement”, but it is then realized that the text in question is relevant, in relevant and applicable parts, also for chuck arrangements 400 and 500, 900 and so forth.

Turning first to FIGS. 1-5, the invention generally relates to a chuck arrangement 100 for fastening a workpiece W, the workpiece being arranged to rotate such as in a lathe or similar.

The chuck arrangement 100 is associated with a radial direction R, an axial direction A and an angular direction V, together defining a polar coordinate system. In particular, the chuck arrangement 100 is arranged to rotate, with the fastened workpiece W, in the angular direction V about a central axial A axis 101.

The chuck arrangement 100 can typically be disassembled at least to some degree. The chuck arrangement 100 illustrated in FIG. 1 is in a fully assembled state, with all chuck jaws 130 mounted and ready for clamping the workpiece W, herein denoted the “assembled state” of the chuck arrangement 100. As will become clear below, the chuck jaws 130 can be mounted in various radial R positions using various mounting mechanism. In the assembled state of the chuck arrangement 100, the chuck jaws 130 can be mounted in any desired such radial R position, but normally they will all be mounted in the same corresponding radial R position for symmetric clamping of the workpiece W.

The chuck arrangement 100 hence comprises at least two chuck jaws 130, arranged to cooperate to fasten the workpiece W by clamping. More particularly, each of the chuck jaws 130 is arranged to, in said assembled state, be radially R displaceable into a respective clamping position to apply a radial R clamping force C to the workpiece W being held by the chuck arrangement 100. Hence, the chuck arrangement 100 is arranged to clamp the workpiece W by the chuck jaws 130 moving radially R into a clamping position and there to apply a radial R clamping force C onto the workpiece W from at least two different radial R directions.

The chuck arrangement 100 can also comprise three chuck jaws 130, or even four chuck jaws 130 or more. Normally, the chuck jaws 130 will be equidistantly oriented along the angular V periphery of the main rotary body 102 (below).

The chuck arrangement 100 further comprises radially R extending tracks 120, such as one radial track 120 per chuck jaw 130. Each radial track 120 is specifically designed and arranged to receive and accommodate a respective one of the chuck jaws 130 so that the chuck jaw 130 in question is radially R adjustable with respect to and along the radial track 120. It is understood that various standard sizes and shapes exist for such radial tracks in chuck arrangements, and that it in some cases can be possible to use a particular chuck jaw with a particular radial track even if the radial track in question was not specifically designed for that particular chuck jaw but merely following a standard that the chuck jaw in question is also compatible with, and vice versa.

Each one of said radial tracks 120 has a radial R inner end 121, in other words an end of the radial track 120 arranged radially R towards the central axis 101.

The radial track 120 can be arranged in, and in relation to, a main rotary body 102 of the chuck arrangement 100. The main rotary body 102 can be in the form of an integrated or aggregated piece of material, where the radial track 120 is formed as, or in a radially R extending elongated recession of, the main rotary body 102.

The inner end 121 can be a closed end in the sense that the inner end 121 comprises an end wall, being more or less perpendicular to the radial direction R hence marking the end of the track 120.

Each one of the radial tracks 120 can also have a radial R outer end, which can be an open end in the sense that it does not comprise a corresponding end wall but is rather defined by the radial track 120 running all the way up to, and through, a radial R periphery and/or envelope surface of the main rotary body 102.

It is understood that the radial track 120 is normally radially R movable in relation to the rest of the chuck arrangement 100, such as in relation to the main rotary body 102. This is conventional as such, and can be accomplished in any of a number of different ways, such as the track being formed in a movable sled mechanism in turn being radially movable by actuating a tensioning mechanism of the chuck arrangement 100. Therefore, this will not be described in any detail herein.

Moreover, each of said chuck jaws 130 comprises a respective t-slot nut 150 and a first chuck jaw part 132. In the following, the chuck jaw 130 will be described as having a first chuck jaw part 132. It is realized that the first chuck jaw part 132 can refer to the chuck jaw 130 as a whole or to a subpart of the chuck jaw 130, such as a backing chuck jaw or any other part of the chuck jaw 130 arranged to fasten to the track 120 via the t-slot nut 150.

The t-slot nut 150 has a first radial end 151 and a second radial end 153, and is arranged to move along the radial track 120 and to radially R fix the first chuck jaw part 132 in relation to the track 120. As is conventional per se, this can be accomplished by the t-slot nut 150 having a general upside-down “T”-shape, including angularly V extending (when mounted in the track 120) side bars with axially A facing support surfaces 159 in turn arranged to engage with corresponding angularly A facing support surfaces 123 of the radial track 120. This is conventional as such, and is illustrated by way of example in the Figures. It is understood that the details of the engagement between the t-slot nut 150 and the radial track 120 can vary, where what is important is that the t-slot nut 120 serves to fasten the chuck jaw 130 to the track 120 by externally threaded fixing screws 131 pulling the t-slot nut 120 towards the chuck jaw 130, thereby creating friction preventing the chuck jaw 130 from moving radially R in relation to the track 120.

The t-slot nut 150 comprises internally threaded holes 155, each arranged to receive and threadedly engage with a fixing screw 131.

The cuck jaw 130 (such as the first chuck jaw part 132) comprises at least one through hole 133 that is arranged to receive and accommodate a fixing screw 131, such as the same fixing screw 131 that engages with the internally threaded hole 155 in question.

The chuck jaw 130 (such as the first chuck jaw part 132) is arranged to be fixed to the radial track 120 by inserting at least one fixing screw 131 through the through hole 133, into one of the internally threaded holes 155 and threadedly engage, by screwing, with the internally threaded hole 155 in question, thereby pulling together the first chuck jaw part 132 and the t-slot nut 150. This pulling together presses said axial A support surfaces 123, 159 together, and thereby mechanically locks the first chuck jaw part 132 to the radial track 120. The locking is hence via the t-slot nut 150, and in particular fixes the radial R position of the first cuck jaw part 132 to the radial track 120.

Once the first chuck jaw part 132 is locked to the radial track 120, it can be moved using the chuck arrangement's 100 tensioning mechanism to move the first chuck jaw part 132 radially R into abutment/engagement with the workpiece W and to apply said radial clamping force C. This tensioning then works by moving the track 120 itself, and with it the chuck jaw 130.

The t-slot nut 150 is arranged so that it can be inserted into the track 120, for instance, by being introduced at and through the open outer end 122 of the track discussed above, with either of the first 151 and second 153 radial ends first. Hence, there are two possible angular V orientations of the t-slot nut 150 when accommodated in and along the track 120, the two possible angular V orientations being separated by an angular V rotation of the t-slot nut 150 of 180°, the rotation being in a plane perpendicular to the axial direction A.

Moreover, both the first radial end 151 and, after such turning 180° of the t-slot nut 150, its second radial end 153 are both arranged to be positioned at a respective defined radial R distance from the radial inner end 121 of the track 120. See FIGS. 6a, 7a and 8a. By way of example, it is understood that equivalently, the defined respective radial distance can instead be described in relation to the central axis 101 or in relation to some other well-defined radial R coordinate of the chuck arrangement 100.

In some embodiments, the defined respective radial distance between the respective radial end 151, 153 of the t-slot nut 150 and the inner end 121 of the track 120 can be reached by fully introducing the t-slot nut 150, in the corresponding direction, into the track 120. It may be the case that said defined radial distance for both insertion directions is the same, such as 0 mm (direct abutment), for instance in the case wherein an abutment end surface 152 of the first radial end 151 is arranged to directly abut a corresponding abutment surface of the inner end 121 of the track 120 when the t-slot nut 150 is fully inserted into the track 120, and further when an abutment end surface 154 of the second radial end 153 is arranged to directly abut against the same abutment surface of the inner end 121 when the t-slot nut 150 is turned 180° and fully inserted into the track 120. In other embodiments, the defined radial distance between the respective radial end 151, 153 of the t-slot nut 150 and the inner end 121 of the track can differ between the two insertion directions of the t-slot nut 150 in relation to the track 120—what is important is that the insertion of the t-slot nut 150 into the track 120 in either direction allows for the t-slot nut 150 to be arranged at the corresponding well-defined radial R distance, or in a well-defined radial R position in relation to some selected radially R fixed point, in an unambiguous manner. In preferred embodiments, this is achieved by fully inserting the t-slot nut 150 into the bottom of the track 120 in either direction, but other ways to achieve the unambiguous reaching of said radial distance or position are foreseen, including using cooperating guide means on the t-slot nut 150 and in the track 120, for instance as a surface protrusion cooperating with a corresponding surface recess to define a particular radial R position of the t-slot nut 150; or by using a separate distance means inserted between the inner end 121 and the radial end 151 and/or 153 in question.

Said abutment surface 152, 154 of the first radial end 151 and the second radial end 153, respectively, can at least in part share a common shape, such as a flat or a curved shape. The common shape can be at least in part complementary to a corresponding abutment surface shape of the inner end 121 of the track 120.

In some embodiments, the defined radial distance between the respective radial end 151, 153 of the t-slot nut 150 and the inner end 121 of the track is reached to a precision of at the most 0.5 mm, such as at the most 0.2 mm, such as at the most 0.1 mm, in the radial direction R, by introducing the t-slot nut 150 in the intended manner, such as until full insertion with or without distance means, or insertion until full engagement between said cooperating guide means.

In the Figures, t-slot nuts 150, 250 and 350 (FIGS. 1-8b), as well as t-slot nuts 650, 750 and 850 (FIGS. 34a-34c) have identically shaped first 151, 251, 351, 651, 751, 851 and second 153, 253, 353, 653, 753, 853 radial ends; whereas t-slot nuts 450, 550 (FIGS. 9-33) have a respective protrusion at their first end 451, 551 that protrudes further than a respective protrusion at their second end 453, 553, the protrusion in question comprising said respective abutment surface 452, 454; 552, 554; and t-slot nut 950 (FIGS. 36a-36m) have a first end 951 the shape of which differs from its second end 953.

Since the radial R position of the t-slut nut 150 along the track 120 thus becomes and is well-defined once inserted in any of the manners described and exemplified above, each of the internally threaded holes 155 then also has a well-defined radial R position in relation to the track 120. It is pointed out that a respective radial R distance between each of the internally threaded holes 155, such as its central axis, and each of the ends 151, 153 is known.

In particular, for each internally threaded hole 155 one can define a respective radial distance 157 from the radial inner end 121 of the track 120 (or, for instance, from the central axis 101 of the chuck arrangement 100) to the central axial A axis of the internally threaded hole 155 in question. See, for instance, FIGS. 6a-8b. It is understood that, as the internally threaded holes 155 are arranged along the t-slot nut 155 in the radial direction R when the t-slot nut 150 is inserted into the track 120, the respective radial distances 157 for the different internally threaded holes 155 are different as long as the t-slot nut 150 is only inserted into the defined radial position in one direction. The respective radial distances 157 of the different internally threaded holes 155 then form a first collection of radial distances 157, that are all different.

Once the t-slot nut 150 is turned 180°, and inserted into the track 120 in the opposite direction, a second collection of radial distances 157 arises, namely the collection of the corresponding distance (as in the first collection) between the inner end 121 (or, for instance, the central axis 101) and an axial central axis of the internally threaded hole 155 in question.

All radial distances 157 in said first and second collections are measured in relation to the same radially R fixed and well-defined point (such as the inner end 121 or the central axis 101).

It is understood that the radial distances 157, 257, 357 illustrated in FIGS. 6a-8b are marked as the respective distance between each internally threaded hole 155, 255, 355 and either one of the radial ends 151, 153; 251, 253; 351, 353, but that the radial distances 157, 257, 357 are in fact measured from a point at the track 120. Since the abutment surface 152, 154; 252, 254; 352, 354 is in direct abutment with the corresponding abutment surface of the inner end 121 of the track 120, this is the same thing in the examples shown in FIGS. 6a-8b.

In general, once said defined radial distances between the track 120 and the t-slot nut 150 have been established, at least two, at least three, most, or even all, of the internally threaded holes 155 are arranged non-symmetrically with respect to their radial positions along the t-slot nut 150.

For a combined collection of such radial distances 157, being the first collection together with the second collection, in some embodiments there are no two radial distances 157 that are the same in such combined collection, or at least this can be true for the corresponding radial distances associated with at least two, or even at least three, different internally threaded holes 155. It is understood that, in such combined collection, each internally threaded hole 155 will typically be associated with two different radial distances 157, each in turn associated with its own insertion direction of the t-slot nut 150.

In other words, the internally threaded holes 155 can be distributed along a radial R length of the t-slot nut 150 so that a combined collection of radial distances 157 associated with at least two, or even at least three, of the internally threaded holes 155 is “distributed” in the sense that no two such radial distances 157 are the same. Further restating what has been explained above, said combined collection of radial distances 157 can then comprise a respective radial distance 157 from the radial inner end 121 of the track 120 to a respective central axis of each of the internally threaded holes 155 in question for both when the first radial end 151 and second radial end 153 is positioned at the defined radial R distance of the t-slot nut 150 from the radial inner end 121 of the track 120.

Respective axes of the at least two, or even at least three, internally threaded holes 155 can be parallel.

Such a chuck arrangement 100 will allow the first chuck jaw part 132 to be selectively mountable to the track 120 in two or more different well-defined radial positions without an operator having to perform any measurement to achieve such a well-defined radial position. By inserting the t-slot nut 150 into the track 150 to the well-defined radial position as described above in a first direction, and fastening the first chuck jaw part using said at least two internally threaded holes 155, the first chuck jaw part 132 ends up in a first well-defined radial position in relation to the track 120; and by inserting the t-slot nut 150 into the track 150 to the well-defined radial position as described above in a second, opposite, direction, and fastening the first chuck jaw part using said at least two internally threaded holes 155, the first chuck jaw part ends up in a second, different, well-defined radial position in relation to the track 120. Depending on the number of internally threaded holes 155 of the t-slot nut 150, it is also possible to vary the well-defined radial position of the first chuck jaw part 132 by using different sets of two or three internally threaded holes 155 (see below for more details).

It is noted that conventional t-slot nuts are not typically fully inserted into their tracks, but are slidable along the tracks so as to allow radial positioning of the corresponding chuck jaw part fastened using the t-slot nut to the track. In general, there is a need to be able to selectively position the chuck jaw part in several different well-defined radial positions in relation to the track in question. In the conventional case, this normally takes place using measurement of the radial position of the chuck jaw.

In some embodiments, a minimum distance, in terms of radial distance difference, between any at least one, at least two or at least three pairs, or most pairs, or even all pairs, of adjacent radial distances 157 in the combined collection of radial distances 157 (when the radial distances in the combined collection are ordered) can be more than 2 mm, or even more than 4 mm.

Alternatively, said minimum distance can be related to a maximum radial freedom of movement, e.g. jaw stroke, of the track 120 in relation to the rest of the chuck arrangement 100, using the tensioning mechanism of the chuck arrangement 100 or similar. Then, said minimum distance can be less than the maximum radial freedom of movement.

Correspondingly, a maximum distance, in terms of radial distance difference, between any at least one, at least two or at least three pairs, or most pairs, or even all pairs, of adjacent radial distances 157 in the combined collection of radial distances 157 can be less than 15 mm, less than 10 mm, less than 8 mm or even at the most 5 mm.

Alternatively, the maximum distance can be less than said maximum radial freedom of movement.

For said minimum and/or maximum distances, it can be true that it applies to at least one, at least two, at least three, at least four, at least five, at least six, at least seven, at least eight, at least nine, at least ten, or even at least twelve, different adjacent pairs of radial differences 157, for instance for such adjacent such pairs arranged next to each other in sequence along the t-slot nut 150.

In some embodiments, a group of at least two, or at least three, or at least five, or at least ten, or even all, of the radial distances 157 in the collection of radial distances 157 are equidistantly arranged.

What has been said above regarding the distribution of the radial distances can also apply to a broader distribution of available radial distances achievable by selecting various mounting orientations of one or more of chuck jaw 130 component parts 130, 131, 132, 135, 136, 150 as described herein and in particular below.

As is illustrated in the Figures, the chuck arrangement 100, such as the main rotary body 102 and in particular the track 120, can generally comprise a set of gripping teeth 110 associated with the track 120. Such gripping teeth 110 are used to, together with the above-described friction locking by the fixing screw 131, lock the radial R position of the chuck jaw 130 (such as the first chuck jaw part 132) to the track 120.

Namely, the chuck jaw 130 (such as the first chuck jaw part 132) comprises a corresponding set of gripping teeth 134 (see FIG. 9e showing gripping teeth 434), allowing the chuck jaw 130 (the first chuck jaw part 132) to be positioned in any one of a discrete set of radial R positions by said gripping teeth 110, 134 engaging to define such a radial R position of the chuck jaw 130 in relation to the track 120.

It is understood that gripping teeth 110, 134 then define a discrete set of radial R positions, one for every tooth 110, 134.

Then, a radial distance 157 between at least one pair, or several pairs, or each pair, of adjacent radial distances 157 in the collection of radial distances 157 can be equal to the radial R distance between a predetermined number of said gripping teeth 110, 134. In other words, by adjusting the insertion direction of the t-slot nut 150 and/or what internally threaded holes 155 that are used for the fastening of the first chuck jaw part 131 to the track 120 (or changing the orientation of any other chuck jaw 130 component part as described below), the radial R position of the chuck jaw 130 can be adjusted across a discrete set of radial R positions, where jumping from one at least one, several, or all, of the discrete set of radial positions to an adjacent radial position corresponds to moving the chuck jaw 130 a certain number of teeth 110, 134. Such number of teeth 110, 134 can, for instance, be between 1 and 10, such as between 2 and 5, teeth 110, 134.

As explained above, the asymmetry of the radial distribution of the internally threaded holes 155 with respect to insertion direction of the t-slot nut 150 makes it possible to achieve up to twice as many available radial positions of the chuck jaw 130 by turning the t-slot nut 150 180° in the track 120.

Another way to achieve more available radial positions of the chuck jaw 130, that can be used in isolation or in combination with the asymmetrical distribution of the internally threaded holes 155, is to provide at least three internally threaded holes 155 in the t-slot nut 150. This way, the chuck jaw 130 (such as the first chuck jaw part 132) can be fastened to the t-slot nut 150 in at least two radially R different positions using at least two, or exactly two, through holes 133 in the chuck jaw 130 (such as the first chuck jaw part 132) for each such radial R fastening position.

It is noted that conventional t-slot nuts are typically intended to be fastened using two internally threaded holes. In some embodiments of the present invention, the t-slot nut 150 can be fastened to the chuck jaw 130 using fixing screws 131 attaching to two of the internally threaded holes 155, but in some embodiments three of the internally threaded holes 155 can be used also. This is illustrated in the various examples in the Figures.

Hence, in FIGS. 2-4, the t-slot nut 150 has three internally threaded holes 155 and the first chuck jaw part 131 is fastened to the t-slot nut 150 using different adjacently arranged pairs of two out of the three internally threaded holes 155. Whereas t-slot nut 150 has three internally threaded holes 155, t-slot nut 250 (FIGS. 7a-7b) has four internally threaded holes 255 and t-slot nut 350 (FIGS. 8a-8b) has five internally threaded holes 355. In FIGS. 9-14, the t-slot nut 450 has three internally threaded holes 455 and the first chuck jaw part 431 is fastened to the t-slot nut 450 using different adjacently arranged pairs of two out of the three internally threaded holes 455, whereas in FIGS. 15a-33, the t-slot nut 550 has five internally threaded holes 555 and the first chuck jaw part 531 is fastened to the t-slot nut 550 using different pairs of non-adjacent two (or adjacent) out of the five internally threaded holes 555.

To achieve this flexibility of the radial placement of the chuck jaw 130, the number of through holes 133 in the chuck jaw 130 (such as the first chuck jaw part 132) can generally be smaller than the number of internally threaded holes 155 in the t-slot nut 150. At any rate, the number of fixing screws 131 used to fasten the chuck jaw 130 (first chuck jaw part 132) can be smaller than the number of internally threaded holes 155 in the t-slot nut 150.

In practice, the t-slot nut 150 can comprise three internally threaded holes 155, but in some embodiments it can comprise at least four, or even at least five, internally threaded holes 155.

In any embodiment, two, several, or all, of the central axes of the respective internally threaded holes 155 can be equidistantly arranged along the radial R length of the t-slot nut 150. The t-slot nut 150 can also have two or more groups of internally threaded holes 155 that are, within the group in question, equidistantly arranged in the radial direction R.

Adjacently and equidistantly arranged internally threaded holes 155 can be arranged at intra-hole radial R distances that are the same, half, one-third or one-fourth of the intra-hole radial R distances of adjacently arranged through holes 133 of the chuck jaw 130.

As is exemplified in FIGS. 7a-7b and 8a-8b, at least one, at least two, or even all, of the internally threaded holes 155 (in FIGS. 7a-8b internally threaded holes 255 and 355) can be blind holes. In other words, the internally threaded holes 255, 355 in question are either not through holes through the t-slot nut 250, 350 in question, or the internally threaded holes 255, 355 at least comprises a partly closed bottom arranged to prevent the fixing screw 131 to reach all the way through the t-slot nut 250, 350. This provides increased material strength to the t-slot nut 150, which is desirable in some embodiments such as when there is a larger number of internally threaded holes 155 and/or when the internally threaded holes 155 are arranged close to each other or even overlapping.

Namely, in such and other embodiments at least two of the internally threaded holes 155 partly overlap in the radial R direction. The overlap can, for instance, be pairwise between one or several pairs of adjacently arranged internally threaded holes 155, and/or more than two adjacently arranged internally threaded holes 155 can be arranged to partly overlap one the other along the radial direction R of the t-slot nut 150. There may also be two or more groups of internally threaded holes 155 according to the above, and two, three or more, or even all, internally threaded holes 155 in the or each such group can be partly overlapping radially R within the group in question.

Furthermore, in such and other embodiments the set of internally threaded holes 155 can comprise internally threaded holes 155 of at least two hole diameters, such as at least one or at least two internally threaded M10 hole in addition to at least one or at least two internally threaded M12 hole. Internally threaded holes 155 of different hole diameters can be arranged as adjacent pairs of internally threaded holes 155 along the radial direction R of the t-slot nut 150. This provides flexibility regarding what dimensions of fixing screws 131 that can be used with the t-slot nut 150 to fasten it to the chuck jaw 130.

Moreover, in such and other embodiments the set of internally threaded holes 155 can be radially R distributed to provide at least two, such as at least three, different standard radial R distances between the internally threaded holes 155 as measured from hole centre to hole centre, perpendicularly to respective axial directions of parallel such internally threaded holes 155. Such standard radial R distances can be, for instance, 20 mm, 25 mm and/or 30 mm. This provides flexibility regarding what distances between through holes 133 of the chuck jaw 130 (first chuck jaw part 132) that can be used with the t-slot nut 150.

These features can be combined in various ways, such as is exemplified in FIGS. 34a-34c.

Hence, FIG. 34a shows a t-slot nut 650 with a first radial end 651 having abutment surface 652; a second radial end 653 having abutment surface 654; and internally threaded holes 655 that overlap two-by-two in pairs along the radial direction R of the t-slot nut 650. As can be seen in FIG. 34a, this admits the mounting of fixing screws 131 at different locations, but also using different hole distances (20 mm, 25 mm, and 30 mm, respectively).

FIG. 34b shows a t-slot nut 750 with a first radial end 751 having abutment surface 752; a second radial end 753 having abutment surface 754; and internally threaded holes 755, four of which are partly overlapping, forming a cluster or group (above). The two remining internally threaded holes 755 are partly overlapping, forming a separate cluster or group. Six of the internally threaded holes 755 are relatively narrower, such as dimension M10, whereas two of the internally threaded holes 755 are relatively wider, such as dimension M12. As indicated in FIG. 34b, a chuck jaw 130 can be fastened at various locations along the t-slot nut 750 using different combinations of fixing screws 131 and/or fixing screw 131 distances, including 20 mm, 25 mm and 30 mm.

FIG. 34c shows a t-slot nut 850 with a first radial end 851 having abutment surface 852; a second radial end 853 having abutment surface 854; and internally threaded holes 855. The internally threaded holes 855 are arranged in two clusters or groups of partly overlapping internally threaded holes 855, each cluster or group having a relatively wider and a relatively narrower internally threaded hole 855. The clusters or groups are mirrored in relation to each other, with the relatively wider internally threaded holes 855 arranged furthest from each other. As indicated in FIG. 34c, this allows various placements of chuck jaws 130 with different combinations of fixing screws 131 and/or fixing screw 131 distances, including 20 mm, 25 mm and 30 mm. it is realised that more than two pairs of such alternating clusters or groups having a respective narrow and a respective wide internally threaded hole 855 can be provided, where such clusters or groups can themselves be radially R separated or partly overlapping.

In general, the number and order of internally threaded holes 155 of same and/or different size can be arranged in various orders and possibly clusters or groups so as to achieve specific goals in terms of strength and flexibility for use cases with one or several different chuck jaws 130 having same or different fixing screw 130 distances and/or same or different fixing screw 130 dimensions.

It is preferred for material strength reasons that no internally threaded holes 155 are open in the radial direction R at either end 151, 153. Using partly overlapping internally threaded holes 155 thus enables using more internally threaded holes 155 for a particular radial R length t-slot nut 150.

For similar reasons, two partly overlapping internally threaded holes 155 of different cross-section will generally provide a stronger t-slot nut 150 as compared to two partly overlapping internally threaded holes 155 of the same cross-section. For instance, in partly overlapping embodiments internally threaded holes 155 with relatively smaller cross-section can be arranged alternatingly with internally threaded holes 155 with relatively larger cross-section, and partly overlaps can be arranged between all internally threaded holes 155, between pairwise adjacent internally threaded holes 155, or similar.

In some embodiments, one or several of the internally threaded holes 155 can have a relatively small cross-section, such as an M10 thread dimension, and the corresponding fixing screw 131 can then have a corresponding small cross-section (in this example M10). Then, the through hole(s) 133 and/or 139 can have a relatively larger cross-section, such as corresponding to, and capable of accommodating, an M12 thread dimension. In other words, the fixing screw 131 is used to fix the chuck jaw 130 to the t-slot nut 150 using a fixing screw 131 that has a relatively smaller cross-sectional diameter than the through hole(s) 133 and/or 139. This may offer improved flexibility in terms of a range of available chuck jaws 130 that the t-slot nut 150 can be used with, due to slight misalignment of the through holes 133 across different chuck jaws 130. Of course, the head of the fixing screw 131 needs to be big enough to engage with an axial A end of the through hole 133, 139 in question.

In some embodiments, the internally threaded holes 155 are radially R distributed along the t-slot nut 150 so that at least one internally threaded hole 155 that does not overlap with another internally threaded hole 155 is available for use to fasten the chuck jaw 130 with a first fixing screw 131, where a second internally threaded hole 155 that does overlap with another internally threaded hole 155 is simultaneously used to fasten the chuck jaw 130 with a second fixing screw 131. The internally threaded holes 155 may be distributed along the radial direction R of the t-slot nut 150 so that this is true for both insertion directions of the t-slot nut 150.

In some embodiments, the t-slot nut 150 comprises both a first collection of internally threaded holes 155 having relatively large cross-sections and a second collection of internally threaded holes 155 having relatively small cross-sections (the cross-sections being “relative” as compared across said collections, the expression “relative” being used in this manner here and elsewhere in the present specification). Then, the internally threaded holes 155 of the first collection may on average be located at a different radial R location than an average radial R location of the internally threaded holes 155 of the second collection. Then, for high-speed applications the t-slot nut 150 can be inserted into the track 120 so that the internally threaded holes 155 of the first collection on average are located relatively radially R further out from the central axis 101 than the internally threaded holes 155 of the second collection, which will focus the weight of the t-slot nut 150 towards the centre of the chuck arrangement 100.

In applications with overlapping internally threaded holes 155, the t-slot nut 150 can be used so that a fixing screw 131 engages with a radially R outermost internally threaded hole 155 in a particular pair of overlapping internally threaded holes 155 when the t-slot nut 150 is inserted into the track 120 in a first direction, and so that a fixing screw 131 engages with the other internally threaded hole 155 in said pair when the t-slot nut 150 is inserted into the track 120 in a second, opposite, direction (this other internally threaded hole then being the radially R outermost internally threaded hole 155 in said pair). This provides a combination of strength and flexibility to the chuck arrangement 100 for applications where the radial tensioning of the chuck arrangement 100 is inwards. For applications where the radial tensioning of the chuck arrangement 100 is outwards, the fixing screws 131 can instead engage with the respective radially R innermost internally threaded hole 155 for each insertion direction of the t-slot nut 150.

Particular embodiments that can be useful in various circumstances include:
Combining one or more internally threaded holes 155 having relatively large cross-section with one or more internally threaded holes 155 having relatively small cross-section so that the one or more internally threaded holes 155 with relatively large cross-section are radially R surrounded by internally threaded holes 155 with relatively small cross-section. This makes it possible to use relatively smaller-dimension screws radially R closer to the gripping surface 138 of the chuck jaw 130, which is desired in some applications.
Combining two internally threaded holes 155 having relatively large cross-section with one internally threaded hole 155 having relatively small cross-section so that the relatively small cross-section internally threaded hole 155 is not located between the two relatively large cross-section internally threaded holes 155 and so that a radial R distance centre-to-centre between the centrally located relatively large cross-section internally threaded hole 155 to the other relatively large cross-section internally threaded hole 155 is different from a radial R distance centre-to-centre between the centrally located relatively large cross-section internally threaded hole 155 to the relatively small cross-section internally threaded hole 155.
Combining one or more internally threaded holes 155 having relatively large cross-section with one or more internally threaded holes 155 having relatively small cross-section so that the respective internally threaded hole 155 located at each radial R end of the t-slot nut 120 is an internally threaded hole 155 with relatively large cross-section. This provides improved strength.

Larger-dimension fixing screws 131 are of course stronger, and are typically used with larger chuck jaws 130. However, such chuck jaws 130 can normally also be used with smaller-dimension fixing screws 131 in one or both of the through holes 133 of the chuck jaw 130.

Using a combination of at least two differently-dimensioned internally threaded holes 155 makes it possible to allow not all internally threaded holes 155 to form a partly overlapping cluster or group of such internally threaded holes 155, but instead allow at least two groups of such internally threaded holes 155 to be completely separated and hence not overlap at all. This in turn increases the strength of the t-slot nut 150, and provides a larger contact surface between the fixing screw 131 and the internally threaded hole 155, while keeping the flexibility with respect to fastening positions.

For instance, conventional 10 inch and 8 inch chuck jaws typically use M12 fixing screws, but at a fixing screw distance of 30 mm and 25 mm, respectively. 6 inch chuck jaws, on the other hand, may use weaker M10 fixing screws and a fixing screw distance of 20 mm. By combining internally threaded holes 155 of different dimensions, for instance as exemplified in FIGS. 34a-c, it is possible to fasten the heaviest 10 inch chuck jaws using two M12 fixing screws; to fasten the 8 inch chuck jaws using a combination of one M12 fixing screw together with one M10 fixing screw; and to fasten the 6 inch chuck jaw using two M10 fixing screws. In particular, it becomes possible to fasten either a 10 inch chuck jaw or a 6 inch chuck jaw using the same t-slot nut 150.

By making the t-slot nut 650, 750, 850 radially R longer, with more internally threaded holes 655, 755, 855, the number of possible radial R fixing positions for each insertion direction of the t-slot nut 650, 750, 850 increases.

Turning to the chuck jaw 130, in some embodiments the chuck jaw 130 (such as the first chuck jaw part 132) comprises at least two through holes 133, or even at least three through holes 133, for said fixing screws 131.

As is exemplified by first chuck jaw parts 132, 432 and 532, one of the at least two through holes 133, 433, 533 can be centrally located in relation to the first chuck jaw part 132, 432, 532 whereas another one of the at least two through holes 133, 433, 533 is peripherally located in relation to the first chuck jaw part 132, 432, 532. That a through hole 130 is “centrally located” in relation to the first chuck jaw part 132 herein is intended to mean that a main longitudinal axis of such centrally located through hole 133 is at least closer to a mass centre of the first chuck jaw part 132 than a main longitudinal axis of such peripherally located through hole 133. A supplementary or alternative interpretation is that the first chuck jaw part 132 is symmetric or substantially symmetric, and that the centrally located through hole 133 is arranged to cover, arranged at or arranged near a centre of symmetry and/or a centre of mass along a plane or radial R line being perpendicular to a main longitudinal axis of the centrally located through hole 133. For instance, the first chuck jaw part 132 can comprise three through holes 133, arranged along a line, where the middle hole is “centrally located” whereas the two outer holes are “peripherally located”.

This way, by using a centrally located through hole 133 together with one or more peripherally located through holes 133 in various ways, additional well-defined radial R positions can be reached, in addition to turning the t-slot nut 150 and/or using different pairs of internally threaded holes 155.

In one such example, the centrally located through hole 133 is used together with a first peripheral through hole 133 to fasten the first chuck jaw part 132 to the t-slot nut 150 at a first radial R location in relation to the track 120, and then the centrally located through hole 133 is used together with a different, second peripheral through hole 133 to fasten the first chuck jaw part 132 to the t-slot nut 150 at a second, different radial R location in relation to the track 120. Correspondingly, two holes neither of which is a centrally located through hole 133 can be used together to achieve a certain radial R position. For instance, the first chuck jaw part 130 can comprise more than two through holes 132 without either of them being a centrally located (or peripherally located) through hole.

In another example, the first chuck jaw part 132 can first be fastened, using two through holes 133, to the track 120 at a first radial R location. Then, the first chuck jaw part 132 can be turned 180° about the axial direction A of the chuck arrangement 100, and then the same or a different pair of through holes 133 can be used to fasten the first chuck jaw part 132 to the track 120 at a second, different radial R location.

By combining what through holes 133 that are used with the tuning 180° of the first chuck jaw part 132, numerous different radial R locations can be achieved of the chuck jaw 130 (such as the first chuck jaw part 132) in relation to the track 120.

It is realized that the first chuck jaw part 132 can also be arranged not with through holes 133 along a line, but distributed across a surface perpendicular to the axial direction A in the assembled state of the chuck arrangement 100. Then, the first chuck jaw part 132 can be rotated about the axial A direction to more than two discrete rotary positions, such as at least three, or at least four, such rotary positions, allowing different radial positions when fastened due to different peripheral through holes 133 being arranged at different distances to said centre of symmetry of the first chuck jaw part 132.

The various parts 120, 130, 132, 150 can be designed in relation to each other so that the total collection of radial distances that can be achieved by changing what internally threaded holes 155 to use; the insertion direction of the t-slot nut 150; what through holes 133 to use; and/or the fastening orientation of the first chuck jaw part 132 has the corresponding properties as described above in relation to the combined collection of radial distances 157. In other words, by alternating the different freedoms of movement described a total interval of available discrete, non-overlapping and evenly distributed radial distances can be achieved. For instance, by turning the first chuck jaw part 132 and/or using different through holes 133 the radial distance can be coarsely tuned, such as in steps of 2 cm or more. Then, by turning the t-slot nut 150 and/or using different internally threaded holes 155, the radial distance can be more finely tuned, such as in steps of 5 mm, across the selected 2 cm interval defined by the first chuck jaw part 132. In general, the difference between any pair of adjacent radial R distance positions that can be reached by modifying what through holes 133 to use and/or the mounting orientation of the first chuck jaw part 132 is larger than the distance between any two adjacent radial R distances in the above-discussed combined collection of radial distances.

In other embodiments, each individual step of said adjustments—changing what internally threaded holes 155 to use; the insertion direction of the t-slot nut 150; what through holes 133 to use; and/or the fastening orientation of the first chuck jaw part 132—can affect the resulting radial R position by a set step distance, that can be the same or different for each of the adjustments. In one example, the step distance can be the same or (slightly) less than the jaw stroke of the chuck tensioning mechanism, that in turn can be, for instance, 8 mm.

Then, a desired chuck jaw 130 position can first be set, by performing corresponding adjustments, the desired chuck jaw 130 position then being set with very high precision.

After the adjustment to the well-defined radial R position of the chuck jaw 130, the chuck jaw 130 can be tensioned using said tensioning mechanism.

In a concrete example, to achieve a radial location of 40 mm from an end of the available teeth 110, 134 engagement interval, the first chuck jaw part 132 can be set in a first orientation and the t-slot nut 150 can be set in a first orientation; to achieve a radial location of 45 mm, the first chuck jaw part 132 can be set in its first orientation and the t-slot nut 150 can be set in a second orientation, turned 180°; to achieve a radial location of 50 mm, the first chuck jaw part 132 can be set in a second orientation, turned 180°, and the t-slot nut 150 can be set in its first orientation; and to achieve a radial location of 55 mm, the first chuck jaw part 132 can be set in its second orientation and the t-slot nut 150 can be set in its second orientation.

In the example shown in FIGS. 15a-33, the first chuck jaw part 132 comprises gripping surfaces 538. In the example shown in FIGS. 9-14, on the other hand, the first chuck jaw part 132 does not comprise gripping surface 438. Rather, in the latter example the first chuck jaw part 432 is a backing chuck jaw part, and the chuck jaw 430 further comprises, in addition to the first chuck jaw part 432, a clamping chuck jaw part 435 arranged to be fastened in relation to the first chuck jaw part 432 and in relation to the track 420.

In general in embodiments of this type, having a backing chuck jaw part 432 and a clamping chuck jaw part 435, the clamping chuck jaw part 435 can be rotatable or turnable about the axial direction A. the clamping chuck jaw part 435 can also be made from relatively softer metal material than the backing chuck jaw part 432.

As is shown in FIGS. 9-14, a particular one 436 of the used fixing screws 431, the screw 436 running through one of the through holes 433 of the first chuck jaw part 432, such as a centrally located through hole as described above, can be arranged to also run through a corresponding through hole 439 through the clamping chuck jaw part 435 so as to fasten the clamping chuck jaw part 435 to the backing chuck jaw part 132.

Then, the fixing screw 436 in question can define an axial A pivot/turning axis of the clamping chuck jaw 435 by the clamping chuck jaw 435 pivoting about the fixing screw 436 so long as the fixing screw 436 is not tightened to prevent such pivoting. Expressed differently, the clamping chuck jaw part 435 is arranged to pivot about an axial A pivot axis 437 defined by the fixing screw 136, where the fixing screw 136 can run through said centrally located through hole 133 of the backing chuck jaw part 132.

It is noted that the fixing screw 136 is one of the fixing screws 136, but arranged to run through the through hole 139 of the clamping chuck jaw part 135.

As is also illustrated in FIGS. 9-14, the fixing screw 436 can be the only one of the fixing screws 431 running through a through hole 439 of the clamping chuck jaw part 435; and the fixing screw 436 can be combined with at least one additional fixing screw 431 that does not run through the clamping chuck jaw part 435 but that does run through a different through hole 433 (such as a peripheral hole) through the clamping chuck jaw part 432.

In addition to FIGS. 9-14, FIGS. 1-5 also show an example having a backing chuck jaw part 132 in combination with a clamping chuck jaw part 135.

As shown in FIGS. 1-5, the clamping chuck jaw part 135 can be pivotable about an axial A pivot axis 137, such as defined by fixing screw 136 as described above, and the clamping chuck jaw part 135 can then comprise several gripping surfaces 138, arranged at different radial R distances from, and at different angular V locations in relation to, the pivot axis 137. In other words, by pivoting/turning the clamping chuck jaw part 135 about said pivot axis 137, different gripping surfaces 138 can be exposed, the different gripping surfaces 138 being arranged to grip (clamp) the workpiece W at different radial R distances from the central axis 101 of the chuck arrangement 100.

Alternatively or additionally, and as is also shown in FIGS. 1-5, the clamping chuck jaw part 135 can comprise several gripping surfaces 138 arranged at different radial R distances from the pivot axis 137 and at different axial A locations. In other words, the gripping surfaces 138 can be arranged in two or more “layers”, so that a gripping surface 138 arranged to grip the workpiece W at a different (such as larger) radial R distance from the central axis 101 is reached by moving the workpiece W axially A (such as upwards) in relation to the clamping chuck jaw part 135.

Hence, in the example shown in FIGS. 1-5, the gripping surfaces 138 are distributed both angularly V and axially A; in FIGS. 9-14, the gripping surfaces 138 are distributed only angularly V; and in FIGS. 15a-33, the gripping surfaces 138 are distributed both angularly V and axially A but are present directly on the backing chuck jaw part 532 rather than on the clamping chuck jaw part 534.

Any gripping surfaces 138 arranged axially A further away from the main rotary body 102 as compared to other gripping surfaces 138 are preferably arranged at larger radial R distance from the central axis 101 as compared to said other gripping surfaces 138.

It is noted that these examples are only illustrative, and that any combination of pivotable or non-pivotable backing chuck jaw part 132 with or without different angularly V and/or axially A distributed gripping surfaces 138, as well as any pivotable or non-pivotable clamping chuck jaw part 135 with or without different angularly V and/or axially A distributed gripping surfaces 138, can be employed.

Such use of several different gripping surfaces 138 further adds to the flexibility of the operator of the chuck arrangement 100, with the aim of providing many different predefined clamping positions associated with well-defined radial R locations of the gripping surfaces 138 without having to manually measure the radial R location of the chuck jaws 130.

It is noted that the various different gripping surfaces 138 can also be associated with different gripping surface shapes, such as flat or curved gripping surface shapes, to be able to grip workpieces W of different shapes, such as square, round and elliptical workpieces W.

In the examples provided in FIGS. 2-4 and 10-33, the following applies:

| | | Internally | | Through holes | |
|---|---|---|---|---|---|
| | | threaded | | used (counted | |
| | | holes used | | from radially | |
| | | (counted | | outer, the mid- | |
| | T-slot nut | from | Backing | dle one is | Clamping |
| | insertion | radially | chuck jaw | ”central” when | chuck jaw |
| Figure | direction | outer) | orientation | applicable) | orientation |
| 2 | First | 2, 3 | First | 1, 2 | First |
| 3 | First | 1, 2 | First | 1, 2 | First |
| 4 | First | 1, 2 | First | 2, 3 | First |
| 9 | First | 2, 3 | First | 1, 2 | First |
| 10 | First | 1, 2 | First | 1, 2 | First |
| 11 | First | 1, 2 | Second | 2, 3 | First |
| 12 | Second | 2, 3 | First | 1, 2 | First |
| 13 | Second | 1, 2 | First | 1, 2 | First |
| 14 | Second | 1, 2 | Second | 2, 3 | First |
| 15c | First | 3, 5 | First | 1, 2 | — |
| 16 | First | 2, 4 | First | 1, 2 | — |
| 17 | First | 1, 3, 5 | First | 1, 2, 3 | — |
| 18 | First | 2, 4 | Second | 2, 3 | — |
| 19 | First | 3, 5 | Second | 1, 2 | — |
| 20 | First | 2, 4 | Second | 1, 2 | — |
| 21 | First | 1, 3, 5 | Second | 1, 2, 3 | — |
| 22 | First | 2, 4 | Second | 2, 3 | — |
| 23 | First | 1, 3 | Second | 2, 3 | — |
| 24 | Second | 3, 5 | First | 1, 2 | — |
| 25 | Second | 2, 4 | First | 1, 2 | — |
| 26 | Second | 1, 3, 5 | First | 1, 2, 3 | — |
| 27 | Second | 3, 5 | First | 2, 3 | — |
| 28 | Second | 1, 3 | First | 2, 3 | — |
| 29 | Second | 3, 5 | Second | 1, 2 | — |
| 30 | Second | 2, 4 | Second | 1, 2 | — |
| 31 | Second | 1, 3, 5 | Second | 1, 2, 3 | — |
| 32 | Second | 2, 4 | Second | 2, 3 | — |
| 33 | Second | 1, 3 | Second | 2, 3 | — |

Hence, as described above, the various predefined radial R positions, achieved by inserting the t-slot nut 150 to its radially R well-defined position in a desired insertion direction and then to select what internally threaded holes 155, through holes 133; backing chuck jaw 532 orientation; clamping chuck jaw 135 orientation and/or gripping surface 138 to use, can match a certain radial R position defined by the engagement between the cooperating gripping teeth 110, 134 on the main rotary body 102 and chuck jaw 130, respectively. For instance, a distance between two adjacent radial positions of the above type can correspond to a certain number of teeth 110, 134 in the teeth engagement, such as at least one tooth, such as at least two teeth or at least three teeth; and/or at the most ten teeth, such as at the most five teeth.

To simplify the mounting of the chuck arrangement 100 into its fully mounted state, with each of the chuck jaws 130 in its proper, radially r well-defined position and fully fastened to the track 120 and ready for clamping the workpiece W, each chuck jaw 130 can individually comprise a stop screw 170. The stop screw 170 can be a spring-loaded screw.

As used herein, the term “spring-loaded screw” means a screw that is arranged to apply a spring force onto a surface that it is screwed towards and abuts against before being fully screwed in, and that it by being fully screwed in can be tightened so as to provide a screwing force against said surface which is much larger than the spring force.

One example of such a spring-loaded screw is the screw sold under model name GN615.3 by Wiberger, Sweden. In general, the stop screw can comprise two rigid parts that are separated by a spring means, such as a spiral spring. One of the rigid parts can be arranged to abut and press against the surface, while the other one of the rigid parts can be arranged to engage with the internal threads of the through hole into which the stop screw is screwed.

FIG. 41 is an overview sketch of another example of such stop screw 170, having a first rigid part 171 with outer threads 173; a second rigid part 172 with a conical, pointy end 175. The first 171 and second 172 rigid parts are interconnected by a spiral spring means 173, arranged to press the second rigid part 172 towards a surface (downwards in FIG. 41) when the stop screw 170 engages with a through hole with internal threads and is screwed into the through hole (also downwards in FIG. 41).

It is realized that the spring means can be any type of spring means, such as a compressive or tension spring, a flat spring, a volute spring, and so forth.

Examples of such stop screws 170, 470 are also shown in FIGS. 1-5 and 9-14, respectively.

Hence, the chuck arrangement 100 can further comprise a spring-loaded stop screw 170 of said type, arranged to be accommodated into and run through a corresponding internally threaded axial A through hole 158 in the t-slot nut 150. The through hole 158 can be a separate through hole (FIGS. 1-7b and 9-14), in addition to the internally threaded holes 155, or be the same or aligned with one of the internally threaded holes 155 (FIGS. 8a-8b). The hole 158 can have a smaller cross-sectional radius than holes 155.

The t-slot nut 150 can comprise at least one, or at least two, such axial A through hole 158. Each through hole 158 can be parallel to the internally threaded holes 155 in terms of a main longitudinal direction of the holes 155, 158 in question. External threads of the stop screw 170 is arranged to engage with the internal threads of the through hole 158 so as to control the depth into the trough hole 158 of the stop screw 170 towards an axial abutment surface of the track 120 against which the stop screw 170 is arranged to abut when fully screwed into the through hole 158 and the t-slot nut 150 is arranged in the track 120.

The stop screw 170, and in particular a rigid part thereof that is arranged to abut against the surface and that via a spring means is connected to another rigid part thereof, that in turn is arranged to engage with the internal threads of the through hole into which the stop screw 170 is inserted, can be arranged with a conical abutment surface arranged to come into abutment with said axial abutment surface, the conical abutment surface being hard enough so as to deform the axial abutment surface of the track 120 as a result of the full fastening of the stop screw 170. The deformation of the axial abutment surface will then have a shape corresponding to the conical abutment surface, so that when the stop screw 170 is released and the t-slot nut 150 is moved it is easy to find the exact radial R position of the t-slot nut 150 again at a later point in time, by moving the t-slot nut 150 along the track 120 until the conical abutment surface of the stop screw 170 engages with the deformation, providing haptic feedback to the user. As the stop screw 170 is then again fully fastened, the engagement between the conical abutment surface and the deformation will force the t-slot nut 150 into the exact same radial R position as before.

When accommodated in the through hole 158, the stop screw 170 (such as a spring part of the stop screw 170 in contrast to a screw part thereof) is arranged to press, due to said spring-loading of the stop screw 170, against an axial A abutment surface of the track 120, such as at a bottom of the track 120d. In other words, due to said threaded engagement between the stop screw 170 and the through hole 158 in the t-slot nut 150, the stop screw 170 presses the t-slot nut 150 away from the abutment surface of the track 120. This pressing creates a friction force, such as between a distal end of the stop screw 170 and said abutment surface, that must be overcome to radially R move the t-slot nut 150 in the track 120. The spring force of the spring-loaded stop screw 170 can be selected so that it is possible for an operator to radially R move the t-slot nut 150 along the track 120 without using much force, but at the same time so that the t-slot nut 150 cannot move radially R along the track 120 without being forced to do so. In particular, the friction may be large enough so as not to be overcome by gravity alone as the track 120 (and the chuck arrangement 100) is tilted at various angles.

In some embodiments, such as illustrated in the Figures, the spring-loaded stop screw 170, when pressed against the axial A abutment surface, does not axially A protrude outside of the t-slot nut 150 at an axially A facing side of the t-slot nut 150 being opposite to an axially A facing side of the t-slot nut 150 facing the axial A abutment surface of the track 120. This can be achieved by selecting a length of the stop screw 170 that is sufficiently short in relation to an axial A depth of the through hole 158, and achieves that the stop screw 170 can be used to achieve said friction without interfering with a placement and operation of the chuck jaw 130 parts, such as the backing chuck jaw part 132, in relation to the t-slot nut 150.

As mentioned, when the stop screw 170 is screwed further into the threaded engagement in the through hole 158, a tip of a screw part of the stop screw 170 reaches said axial A abutment surface of the track 120 and, by fastening further, the friction engagement can deepen into a friction sufficiently large so as to prevent any radial R movement of the t-slot nut 150 along the track 120.

FIG. 35 shows a method for mounting and operating the chuck arrangement 100.

In a first step, the method starts.

In a subsequent step, the t-slot nut 150 is inserted into the track 120 with the first radial end 151 radially R inwards. Looking at FIG. 9d, this corresponds to if the fixing screws 431, 436, as well as the chuck jaw parts 432, 435 have yet not been mounted, but only the t-slot nut 450.

In a subsequent step, a rotary orientation and through holes to use for the fixing screws 131 can be selected for the chuck jaw 130 (such as the backing chuck jaw part 132).

In a subsequent step, the chuck jaw 130 (such as the first chuck jaw part 132) is fastened to the track 120 by inserting and tightening a first fixing screw 131 through a first through hole 133 of the chuck jaw 130 (such as the first chuck jaw part 132) and a first internally threaded hole 155 of the t-slot nut 150. This first fixing screw 131 can, for instance, be the right-hand fixing screw 431 in FIG. 9d.

In a subsequent step, at least one additional fixing screw 431 can be used to mount the chuck jaw 130 to the track 120. Such additional fixing screw 431 can be fixing screw 436, that mounts a clamping chuck jaw part 435 to the track 120, through both the clamping chuck jaw part 435 and the backing chuck jaw part 432.

In a subsequent step, a rotary orientation of the clamping chuck jaw part 135 can be selected, and the fixing screw 436 can then be tightened.

In a subsequent step, the chuck arrangement 100 is operated to clamp the workpiece W, for instance as shown in FIG. 1. This may involve an additional step of clamping the workpiece W so that it is securely fastened between the chuck jaws 130. The workpiece W may also, in an additional step, be rotated and machined in a desired manner, such as using a lathe.

In a subsequent step, the workpiece W may be released, by untightening the chuck jaws 130, and removed.

In a subsequent step, the chuck jaw 130 (such as the first chuck jaw part 132) is then released from the track 120 by undoing the first fixing screw 131, and in applicable cases also any additional fixing screws 131, 136 used, and unmounting any chuck jaw parts 130, 132, 135 used.

In a subsequent step, the t-slot nut 150 is removed and then inserted into the track 120 with the second radial end 153 radially R inwards. In other words, the t-slot nut 150 is turned 180° and then reinserted into the track 120.

In a subsequent step, the chuck jaw parts 130, 132 and/or 135 are again fastened to the track 120 by inserting and tightening corresponding one or several fixing screws 131, 136 as described above. The same and/or different fixing screws 131, 136 can be used as before.

This fastening can be preceded by the same or different selection of through holes 133 to use and/or rotary orientation of the chuck jaw parts 130, 132, 135 as described above.

Alternatively to turning the t-slot nut 150 180°, the chuck jaw 130 (such as the first chuck jaw part 132) can be fastened to the track 120 by inserting and tightening the same or a different first fixing screw 131, through the same first through hole 133 of the chuck jaw 130 previously used but a second, different, internally threaded hole 155 of the t-slot nut 150. Hence, instead of turning the t-slot nut 180°, a different set of internally threaded holes 155 are used to fasten the chuck jaw parts 130, 132, 135 to the track 120.

Further alternatively, the first chuck jaw part 132 can be turned 180°, or any other angle depending on the symmetry configuration of the first chuck jaw part 132, about an axial A axis, and the first chuck jaw part 132 can then be fastened to the track 120, using a fixing screw 131 running through a through hole 133 of the first chuck jaw part 132 and an internally threaded hole 155 of the t-slot nut 150, in the new orientation of the first chuck jaw part 132 resulting from said turning.

Also alternatively, using the clamping chuck jaw 135 described above, the clamping chuck jaw 135 can be arranged to expose a different gripping surface 138 to the workpiece W, by turning the clamping chuck jaw 135 about the axial A pivot axis 137 or by preparing to clamp the workpiece W in a different axial A location of the clamping chuck jaw part 135, such as translating the workpiece W in the axial direction A.

It is noted that these alternatives can also be combined in any manner, such as combining any two of them, any three of them or all four of them, so as to achieve a desired radial R position for the chuck jaw 130.

In a subsequent step, the same or a different workpiece W can again be clamped, rotated and machined in a way corresponding to the above.

In a subsequent step, the method ends.

In said inserting, the t-slot nut 150 can be inserted to a defined radial distance from the radial inner end 121 of the track 120, as described above.

FIGS. 36a-36m illustrate a chuck arrangement 900 in subsequent states during mounting of its chuck jaws 930.

In FIG. 36a, the main rotary body 902 is provided, with its three tracks 920 and three t-slot nuts 950. Each t-slot nut 950 has a spring-loaded stop screw 970.

In FIG. 36b, the t-slot nuts 950 have been inserted into the tracks 920. It is noted that the t-slot nuts 950 may be, but do not necessarily have to be, at a fully inserted radial R position or in any other position that is radially R well-defined in some other manner, as explained above. Instead, the t-slot nuts 950 can simply be inserted into the tracks 920.

In FIG. 36c, the spring-loaded stop screws 970 have been screwed into its respective axial through hole 958 in the t-slot nut 950 until spring-loaded contact has been reached with the bottom of the track 920.

In FIG. 36d, a distance-defining tool 980 is introduced. The distance-defining tool 980, that can be included together with any chuck arrangement 900 having at least three chuck jaws 930, comprises three parallel guide pins 981. The guide pins 981, in turn, are arranged in a triangle, a plane of which is perpendicular to a general longitudinal direction of the guide pins 981. In use for alignment of the t-slot nuts 950, the guide pins 981 will generally run axially A. The relative position of the guide pins 981 in said plane can be adjustable, but is fixed when using the distance-defining tool 980 to align the t-slot nuts 950.

Namely, each guide pin 981 is arranged to radially R align with a corresponding internally threaded hole 955 in a respective one of three different t-slot nuts 950 when each of said three different t-slot nuts 950 has been inserted into the corresponding track 920 and radially R positioned at a defined radial distance 957 (see FIG. 36f) from the radial inner end 921 of the track 120 in question.

In FIG. 36e, the distance-defining tool 980, and in particular the guide pins 981, have been inserted into their corresponding internally threaded holes 955 of the t-slot nuts 950, and as a result have forced/dragged/pushed/pulled the t-slot nuts 950 into the predetermined respective radial R position defined by the distance-defining tool 980. The movement of the t-slot nuts 950 takes place against the friction force caused by the spring-loaded stop screws 970, and can be due to an operator manually moving the t-slot nuts 950, the distance-defining tool 980 forcing the t-slot nut 950 to move as a result of the insertion of the guide pins 981 into the internally threaded hole 955, or both.

In FIG. 36f, the distance-defining tool 980 has been removed. Due to the spring-loaded stop screws 970, the t-slot nuts 955 remain in their radial R location without moving.

In FIG. 36g, the first chuck jaw part 932 is placed in its correct location in relation to the t-slot nut 920.

In FIG. 36h, the fixing screw 931 is inserted through one of the through holes 933 and into one of the internally threaded holes 955, and the first chuck jaw part 932 is moved slightly, if necessary, in the radial direction R so that full engagement between the gripping teeth 110, 134 is achieved. This can hence mean that the radial R position of the t-slot nut 950 is moved, being dragged or pushed by the first chuck jaw part 932, such as manually by the operator, slightly away from the radial R position defined by the distance-defining tool 180, and more particularly to the nearest radially R inwards/outwards engagement point between the gripping teeth 110, 134. In this process, the operator can use and exploit the tactile feedback available as a result of the teeth 110, 134 moving and engaging in relation to each other.

In FIG. 36i, the fixing screw 931 has been screwed fully into its fastening position. This step is optional, but may aid to achieve the full engagement between the teeth 110, 134.

In FIG. 36j, the fixing screw 931 and the first chuck jaw part 932 have been removed, and the t-slot nut 950 is fixed into its radial R position by screwing the stop screw 970 in fully and tightening it against the bottom of the track 920.

In FIG. 36k, the first chuck jaw part 932 (which is a backing chuck jaw part) has again been mounted, using fixing screw 931.

In FIG. 36l, the clamping chuck jaw part 935 is provided, together with the fixing screw 936.

In FIG. 36m, the clamping chuck jaw part 935 is fastened into its desired rotary position, by tightening the fixing screw 936. Also, the other two chuck jaws 930 have been mounted in the corresponding manner.

It is understood that, in case the chuck jaw 930 does not include a separate backing chuck jaw part 932 and a separate clamping chuck jaw part 935, the steps relating to the clamping chuck jaw part 935 are omitted or replaced with corresponding steps relating to a chuck jaw 930 having a built-in clamping part.

This procedure, using the distance-defining tool 180 to align the t-slot nuts 950 in the tracks 920 when being temporarily fastened using the spring-loaded stop screws 970; adjusting the t-slot nuts 950 to the closest engagement point between the teeth 910, 934 if necessary; and then fully fastening the t-slot nuts 950 and the chuck jaw parts 932, 935, provides a quick and convenient way to establish the radially well-defined position of the t-slot nut 150 described above, and in relation to which the collections of radial distances are established.

The distance-defining tool 180 may be used to establish such a well-defined radial R position of the t-slot nuts 150 at a distance from a respective fully inserted position of each t-slot nut 150 into the track 120; but also a well-defined radial R position of the t-slot nuts 150 close to such fully inserted position of the track 120. For instance, the distance-defining tool 180 can be used to make sure that the same engagement point between the gripping teeth 110, 134, close to the fully inserted position, is reliably hit every time the chuck jaws 130 are mounted on the chuck arrangement 100. For instance, such engagement point may be a first available full-engagement point between the teeth 110, 134 that is arrived at when moving the t-slot nut 950 radially R outwards from a fully inserted position in the track 920.

In general, the methods and principles described herein to achieve a well-defined radial R position of the t-slot nut 150 are useful for reliably reach the same well-defined radial R position for each t-slot nut 150 every time the chuck jaw 130 in question is mounted. This provides a way to repeatedly and reliably mount the chuck jaw 130 in the same way over and over again, and with the same gripping configuration, for performing a particular machining procedure or similar, without having to manually measure the t-slot nut 150 position.

FIG. 37 shows a method for achieving a defined radial distance, such as the above-discussed radial distance 157. The method is in accordance with what has been described above.

In a first step, the method starts.

In a subsequent step, the t-slot nut 150 is fully inserted into the track 120 so that its first radial end abuts 151 directly with the radial inner end 121 of the track 120.

Alternatively, the the t-slot nut 150 is inserted into the track 120 and using the distance-defining tool 980 to adjust the radial R position of at least three t-slot nuts 150 in relation to each other, the at least three t-slot nuts 150 being radially R movable in a respective track 120.

Further alternatively, a radial R location of the t-slot nut 150 is fine-tuned by temporarily fastening the first chuck jaw part 132 to the t-slot nut 150 and radially R moving the first chuck jaw part 132 so that aligned engagement is achieved between the cooperating gripping teeth 110, 134 arranged on the track 120 and on the first chuck jaw part 132 at a nearest possible radial R location of the t-slot nut 150 for such engagement to be possible.

As has been made clear above, these three alternative steps can also be combined in any manner, such as combining any two of them, or all three.

In a subsequent step, the method ends.

FIG. 38 shows another method. It is understood that the methods shown in FIGS. 35, 37 and 38, and the sequence steps illustrated in FIGS. 36a-36m, can be combined freely.

In a first step, the method starts.

In a subsequent step, the t-slot nut 150 is inserted into the track 120.

In a subsequent step, the spring-loaded stop screw 170 is screwed into the internally threaded axial A through hole 158 of the t-slot nut 150 and into pressing engagement with the axial A abutment surface of the track 120 as described above, so as to create a friction force that must be overcome to radially R move the t-slot nut 150 in the track 120, the friction being due to said spring-loading of the spring-loaded stop screw 170.

In a subsequent step, the chuck jaw 130, such as the first chuck jaw part 132, is brought into loose engagement with the t-slot nut 150 using a fixing screw 131 running through a through hole 133 of the first chuck jaw part 132 and into an internally threaded hole 155 of the t-slot nut 150.

In a subsequent step, the t-slot nut 150 is fine-adjusted radially R, against said friction force, until aligned engagement is achieved between the cooperating gripping teeth 110, 134 arranged on the first chuck jaw part 132 and on the track 120.

In a subsequent step, the chuck jaw 130 (the first chuck jaw part 132) is removed from the t-slot nut 150.

In a subsequent step, the stop screw 170 is fully fastened and radially R locked to the track 120, by screwing it further into pressing engagement with the axial A abutment surface of the track 120.

In a subsequent step, the chuck jaw 130, such as the first chuck jaw part 132, is further fastened to the track 120 using a fixing screw 131 running through a through hole 133 of the chuck jaw 130 (the first chuck jaw part 132) and into an internally threaded hole 155 of the t-slot nut 150.

In a subsequent step, the method ends.

Generally, the fine-adjusting of the t-slot nut 150 to find a closest point of engagement between the gripping teeth 110, 134 as described herein, may in some embodiments be 2 mm or less, such as 1 mm or less, in the radial direction R.

FIG. 39 illustrates a method for operating the distance-defining tool 980, which is also freely combinable with the above-described methods and step sequences.

In general, the invention in some embodiments relates to a kit of parts comprising the chuck arrangement 100 as well as the distance-defining tool 980, 1080, and this method is then for operating such kit of parts to mount the chuck arrangement 100.

In a first step, the method starts.

In a subsequent step, each of at least three t-slot nuts 150 are inserted into a respective track 120, for instance with a respective first radial end 151 of the t-slot nut 150 in question radially R inwards.

In a subsequent step, the radial R positions of said three t-slot nuts 150 are adjusted in concert by inserting a respective one of said three guide pins 981 of the distance-defining tool 980 into a respective internally threaded hole 155 of each t-slot nut 150.

In a subsequent step, each of the three t-slot nuts 150 is fastened to its respective track 120.

In a subsequent step, the method ends.

FIG. 40 is a top view of a distance-defining tool 1080, the distance-defining tool 1080 being adjustable in terms of a particular radial R distance 1083 to impart to the t-slot nuts 150 when the distance-defining tool 1080 is used to a align the t-slot nuts 150 by engaging with a respective internally threaded hole 155 of each t-slot nut 150 in question. To achieve this adjustability, the distance-defining tool 1080 comprises a series of holes 1082 on each of the three arms 1084 thereof, the holes 1082 being arranged to engage with and hold a respective guide pin 1081 that in turn is arranged to be inserted into said internally threaded hole 155 to guide the t-slot nut 150 in question to its intended radial R position 1083. Hence, by placing the guide pin 1081 in one of the four holes 1082 along each arm 1084, the desired well-defined radial R position 1083 is selected. In this and other embodiments, the same radial R position 1083 can be used for all three arms 1084 at any particular point in time.

It is understood that the tool 1080 illustrated in FIG. 40 is merely an example, and that many other mechanisms can be used to achieve such adjustability, such as each arm comprising a sliding mechanism arranged to control a radial R distance 1083 between a hole 1082 and a radial R centre of the tool 1080; and/or other engagement means than holes 1082, such as fastening flanges or similar. The tool 1080 can also comprise a mechanism that synchronizes the selected radial R positions 1083 among the arms 1084, so that one single maneuver step by the operator results in that all three arms 1084 are set into the same well-defined radial R position 1083. This can be achieved by a link arm mechanism, an expanding screw mechanism, or similar.

As mentioned above, a separate distance means can be used to find a defined radial R position of the t-slot nut 150 along the track 120, by placing such a separate means between the inner end 121 of the track 120 and the t-slot nut 150 and fully inserting the t-slot nut 150 until abutment of the separate distance means with both the inner end 121 and the t-slot nut. Such separate distance means can also be used to force a fine-adjustment, against the friction force provided by the stop screw 170, by pressing down such a separate distance tool between the inner end 121 and the t-slot nut 150. In some embodiments, such a separate distance means can be made from plastic or metal and have a thickness corresponding to one tooth 110, 134 width or thereabouts, such as less than about 2 mm.

In cases where the distance between adjacent radial positions are not an even multiple of teeth distances, for instance if the radial R distance between adjacent radial positions is generally 5 mm along the t-slot nut 150 and the teeth distance is 1.5 mm, such a separate distance means can be used to reliably strike the correct tooth every time the chuck jaw 130 is mounted. In such cases, the separate distance means is arranged to radially R displace the t-slot nut 150 along the track 120 a distance that is smaller than said tooth distance.

A further use for such a separate distance means is to position the t-slot nut 150 a few teeth away from its completely bottomed position in the track 120 with the purpose of achieving a certain margin for removing material of the gripping surface 138 as it becomes worn over prolonged use. Using separate distance means, the t-slot nut 150 can then be allowed to move radially R only one tooth or less, instead of a full radial distance 157 of the above-described type as the gripping surface 138 moves radially R inwards in relation to the axial pivot axis 137.

A separate distance means can also be useful for achieving full compatibility of the t-slot nut 150 with a preexisting chuck arrangement having a track that is not exactly as radially R deep as the chuck arrangement 100 together with which the t-slot nut 150 is primarily intended to be used.

The present invention allows for quick and secure fastening of the workpiece W without the operator having to perform any manual measurements of the radial R position of the t-slot nut 150 or the chuck jaw 130, and without having to manually count gripping teeth 110, 134 to find a desired radial R position. This fastening is also repeatable without having to perform such measurements in subsequent repetitions, even when a new operator takes over from a previous operator-all that is required is to document in what way/orientation and in what holes 133, 155 the various parts 150, 130, 131, 132, 135 and/or 136 are to be mounted to achieve a well-defined, unambiguous one of a discrete set of available radial R positions of the t-slot nut 150 in relation to the track 120.

The well-defined radial R position of each t-slot nut 150 achievable using the present invention also decreases the risk of fastening the workpiece W in a non-straight manner, in turn potentially giving rise to unwanted vibrations or other movements of the workpiece W during rotation and machining thereof. Furthermore, the various adjustments of the radial R position described above allows for one single set of parts, including one single t-slot nut 150 in addition to one single chuck jaw 130 and/or one single set of backing chuck jaw part 132 and clamping chuck jaw part 135, to cover and exploit an entire clamping interval of the chuck arrangement 100.

It is also possible, using the present invention, to change the well-defined radial R difference by fastening the chuck jaw 130, such as the first/backing chuck part 132 and/or the clamping chuck jaw 135, in a different orientation, without demounting or even loosening the t-slot nut 150.

In any of the above-described embodiments, it is preferred that each well-defined radial R position achievable by selecting the various mounting orientations of the parts 150, 130, 131, 132, 135 and/or 136 are arranged so that the difference between any two adjacent such radial R positions is equal to or smaller than, such as between 70%-90%, of the jaw stroke of the chuck arrangement 100 tensioning mechanism. This way, when the tensioning mechanism is set at roughly the centre of its adjustable interval and the well-defined radial R position is changed to its adjacent value, the reachable tensioning intervals of the two well-defined radial R positions have a slight overlap.

Above, preferred embodiments have been described. However, it is apparent to the skilled person that many modifications can be made to the disclosed embodiments without departing from the basic idea of the invention.

For instance, the details of the chuck arrangement can be designed in many different ways, as long as the principles described herein and defined in the claims are used.

In general, everything that is said in relation to the various embodiments of chuck arrangements and methods described herein is applicable across embodiments, as long as embodiments are compatible and nothing else is explicitly stated herein. Hence, the embodiments described herein have been selected so as to highlight and explain certain features, and these features can be combined in any way as long as they are mutually compatible.

Hence, the invention is not limited to the described embodiments, but can be varied within the scope of the enclosed claims.

1. A chuck arrangement associated with a radial direction, an axial direction and an angular direction, the chuck arrangement being arranged to rotate in the angular direction about a central axial axis,
the chuck arrangement comprising at least two chuck jaws, each arranged to, in an assembled state of the chuck arrangement, be radially displaceable into a respective clamping position to apply a radial clamping force to a workpiece being held by the chuck arrangement,
the chuck arrangement further comprising radial tracks, each arranged to receive and accommodate a respective one of the chuck jaws so that the chuck jaw can be radially adjustable, each track having a radial inner end;
wherein:
each chuck jaw comprises a respective t-slot nut and a first chuck jaw part,
the t-slot nut has a first radial end and a second radial end, the t-slot nut further being arranged to move along the radial track and to radially fix the first chuck jaw part in relation to the track, the t-slot nut comprising internally threaded holes;
the first chuck jaw part comprises at least one through hole;
the first chuck jaw part is arranged to be fixed to the track by inserting at least one fixing screw through the through hole, into one of the internally threaded holes and threadedly engage with the internally threaded hole in question, thereby pulling together the first chuck jaw part and the t-slot nut,
both the first radial end of the t-slot nut and, after turning the t-slot nut 180°, the second radial end of the t-slot nut is arranged to be positioned at a defined radial distance from the radial inner end of the track,
the internally threaded holes are distributed along a radial length of the t-slot nut so that a collection of radial distances associated with at least two of the internally threaded holes is distributed in the sense that no two such radial distances are the same, the collection of radial distances comprising a respective radial distance from the radial inner end of the track to a respective central axis of each of the internally threaded holes in question for both when the first radial end and second radial end is positioned at the defined distance from the radial inner end of the track.

2. The chuck arrangement of claim 1, wherein respective abutment surfaces of the first radial end and the second radial end share a common shape.

3.-4. (canceled)

5. The chuck arrangement of claim 1, wherein:
the chuck arrangement comprises a set of gripping teeth associated with the track,
the first chuck jaw part comprises a corresponding set of gripping teeth, allowing the first chuck jaw part to be positioned in any one of a discrete set of radial positions by the gripping teeth engaging to define such a radial position, and
a radial distance between at least one pair, or several pairs, or each pair, of adjacent radial distances in the collection of radial distances is equal to the radial distance between a predetermined number of the gripping teeth.

6. (canceled)

7. A chuck arrangement associated with a radial direction, an axial direction and an angular direction, the chuck arrangement being arranged to rotate in the angular direction about a central axial axis,
the chuck arrangement comprising at least two chuck jaws, each arranged to, in an assembled state of the chuck arrangement, be radially displaceable into a respective clamping position to apply a radial clamping force to a workpiece being held by the chuck arrangement,
the chuck arrangement further comprising radial tracks, each arranged to receive and accommodate a respective one of the chuck jaws so that the chuck jaw can be radially adjustable, each track having a radial inner end;
wherein:
each chuck jaw comprises a respective t-slot nut and a first chuck jaw part,
the t-slot nut has a first radial end and a second radial end, the t-slot nut further being arranged to move along the radial track and to radially fix the first chuck jaw part in relation to the track, the t-slot nut comprising internally threaded holes;
the first chuck jaw part comprises at least one through hole;
the first chuck jaw part is arranged to be fixed to the track by inserting at least one fixing screw through the through hole, into one of the internally threaded holes and threadedly engage with the internally threaded hole in question, thereby pulling together the first chuck jaw part and the t-slot nut, and
the number of internally threaded holes in the t-slot nut is at least three, so that the first chuck jaw part can be fastened to the t-slot nut in at least two radially different positions using at least two through holes in the first chuck jaw part for each such radial fastening position.

8. The chuck arrangement of claim 7, wherein the number of through holes in the first chuck jaw part is smaller than the number of internally threaded holes in the t-slot nut.

9.-11. (canceled)

12. The chuck arrangement of claim 7, wherein the first chuck jaw part comprises at least two through holes.

13. The chuck arrangement of claim 12, wherein one of the two through holes is centrally located in relation to the first chuck jaw part whereas the other is peripherally located in relation to the first chuck jaw part.

14. The chuck arrangement of claim 13, wherein;
the first chuck jaw part is a backing chuck jaw part,
the chuck jaw further comprises a clamping chuck jaw part, and
a fixing screw running through the centrally located through hole of the first chuck jaw part is arranged to also run through a corresponding through hole through the clamping chuck jaw part so as to fasten the clamping chuck jaw part to the backing chuck jaw part.

15. The chuck arrangement of claim 14, wherein the clamping chuck jaw part is arranged to pivot about an axial pivot axis defined by the fixing screw running through the centrally located through hole.

16. The chuck arrangement of claim 7, wherein;
the first chuck jaw part is a backing chuck jaw part,
the chuck jaw further comprises a clamping chuck jaw part, and at least one of the following is true:
firstly, the clamping chuck jaw part is pivotable about an axial pivot axis and the clamping chuck jaw part comprises several gripping surfaces, arranged at different radial distances from, and at different angular locations in relation to, the pivot axis; and
secondly, the clamping chuck jaw part comprises several gripping surfaces, arranged at different radial distances from the pivot axis and at different axial locations.

17. The chuck arrangement of claim 7, further comprising:
a spring-loaded stop screw, arranged to be accommodated into and run through a corresponding inner-threaded axial through hole in the t-slot nut and then to be pressed, due to the spring-loading, against an axial abutment surface of the track so as to create a friction force that must be overcome to radially move the t-slot nut in the track.

18. The chuck arrangement of claim 17, wherein the spring-loaded stop screw, when pressed against the axial abutment surface, does not axially protrude outside of the t-slot nut at an axially facing side of the t-slot nut being opposite to an axially facing side of the t-slot nut facing the axial abutment surface of the track.

19. A method for operating a chuck arrangement of claim 1, comprising:
inserting the t-slot nut into the track with the first radial end radially inwards;
fastening the first chuck jaw part to the track by inserting and tightening a first fixing screw through a first through hole of the first chuck jaw part and a first internally threaded hole of the t-slot nut;
operating the chuck arrangement to clamp a workpiece;
releasing the first chuck jaw part from the track by undoing the first fixing screw;
at least one of:
firstly, inserting the t-slot nut into the track with the second radial end radially inwards and fastening the first chuck jaw part to the track by inserting and tightening the first fixing screw, or a second fixing screw, through the first or a second through hole of the first chuck jaw part and the first or a second internally threaded hole of the t-slot nut; and
secondly, fastening the first chuck jaw part to the track by inserting and tightening the first fixing screw, or a second fixing screw, through the first through hole of the first chuck jaw part and a second internally threaded hole of the t-slot nut, the second internally threaded hole of the t-slot nut being different from the first internally threaded hole of the t-slot nu; and
operating the chuck arrangement to clamp a workpiece.

20. The method of claim 19, wherein, in the inserting, the t-slot nut is inserted to a defined radial distance from the radial inner end of the track.

21. The method of claim 20, wherein,
the defined radial distance is achieved by at least one of:
firstly, fully inserting the t-slot nut into the track so that its first radial end abuts directly with the radial inner end of the track;
secondly, inserting the t-slot nut into the track and using a distance-defining tool to adjust the radial position of at least three t-slot nuts in relation to each other, the at least three t-slot nuts being radially movable in a respective track; and
thirdly, fine-adjusting a radial location of the t-slot nut by temporarily fastening the first chuck jaw part to the t-slot nut and radially moving the first chuck jaw part so that aligned engagement is achieved between cooperating gripping teeth arranged on the track and on the first chuck jaw part at a nearest possible radial location of the t-slot nut for such engagement to be possible.

22. The method of claim 19, further comprising:
releasing the first chuck jaw part from the track;
turning the first chuck jaw part 180° about an axial axis; and
fastening the first chuck jaw part to the track, using a fixing screw running through a through hole of the first chuck jaw part and an internally threaded hole of the t-slot nut, in the new orientation of the first chuck jaw part resulting from the turning.

23. The method of claim 19, further comprising:
fastening a clamping chuck jaw part to the first chuck jaw part, the first chuck jaw part then being a backing chuck jaw part of the chuck jaw; and
clamping the workpiece by bringing a first gripping surface of the clamping chuck jaw part into contact with the workpiece;
releasing the workpiece; and
clamping the workpiece by bringing a second gripping surface of the clamping chuck jaw into contact with the workpiece,
where the second gripping surface is either exposed to the workpiece by pivoting the clamping chuck jaw about an axial pivot axis or by translating the workpiece in the axial direction.

24. The method of claim 19, further comprising:
inserting the t-slot nut into the track;
screwing a spring-loaded stop screw of the chuck arrangement into an internally threaded axial through hole of the t-slot nut and into pressing engagement with an axial abutment surface of the track so as to create a friction force that must be overcome to radially move the t-slot nut in the track, the friction being due to the spring-loading;
bringing the first chuck jaw part into loose engagement with the t-slot nut using a fixing screw running through a through hole of the first chuck jaw part and into an internally threaded hole of the t-slot nut;
fine-adjusting, against the friction force, the t-slot nut radially until aligned engagement is achieved between cooperating gripping teeth arranged on the first chuck jaw part and on the track;
removing the first chuck jaw part from the t-slot nut;
fully fastening the stop screw by screwing it further into pressing engagement with the axial abutment surface of the track; and
fastening the first chuck jaw part to the track using a fixing screw running through a through hole of the first chuck jaw part and into an internally threaded hole of the t-slot nut.

25. The method of claim 24, wherein the fine-adjusting of the t-slot nut is 1 mm or less radially.

26. A kit of parts, comprising:
a chuck arrangement according to claim 1, the chuck arrangement comprising at least three chuck jaws; and
a distance-defining tool, comprising three parallel guide pins arranged in a triangle, a plane of the triangle being perpendicular to a general longitudinal direction of the guide pins, each guide pin being arranged to radially align with a corresponding internally threaded hole in a respective one of three different t-slot nuts when each of the three different t-slot nuts are inserted into the corresponding track and radially positioned at a defined radial distance from the radial inner end of the track in question.

27. A method for operating a kit of parts according to claim 26, comprising:
inserting each of three t-slot nuts of the chuck arrangement of the kit of parts into a respective track;
adjusting the radial positions of the three t-slot nuts in concert by inserting a respective one of the three guide pins into a respective internally threaded hole of each t-slot nut; and
fastening each of the three t-slot nuts to the respective track.
